(19) United States
(12) Patent Application Publication
(10) Pub. No.: US 2011/0055071 A1
(43) Pub. Date: Mar. 3, 2011

(54) SYSTEM FOR DETERMINING AND CALCULATING INELIGIBLE COLLATERAL

(75) Inventors: Andrew C. JONES, Greendale, WI (US); Tarik Makota, Lyndhurst, NJ (US); Nanci St. George, Winthrop, MA (US); Edward W. Pflum, Flushing, NY (US); Barbara A. Greene, Stallings, NC (US)

(73) Assignee: Bank of America Corporation, Charlotte, NC (US)

(21) Appl. No.: 12/547,385

(22) Filed: Aug. 25, 2009

(51) Int. Cl. G06Q 40/00; G06Q 10/00

(52) U.S. Cl. 705/38

(57) ABSTRACT

Aspects of this disclosure relate to a computer for determining and calculating ineligible collateral which includes a processor and memory storing computer executable instructions that, when executed, cause the computer to perform a method for determining and calculating ineligible collateral, by receiving data relating to assets or collateral of a client and determining and calculating ineligible collateral based on the data by applying one or more rules or definitions regarding ineligible collateral to the data. The rules and definitions applied to the collateral are variable based on a particular client to which the data relates. According to aspects of the disclosure, the computer is configured to receive client data relating to assets or collateral of a client, search the client data for relevant data, extract the relevant data and create a summary of the relevant data and determine and calculate ineligible collateral by applying one or more rules or definitions regarding ineligible collateral to the relevant data in the summary.

### BACKGROUND

When a lender, such as a financial institution (e.g., a bank or credit union) lends money to a borrower, the lender wants to minimize the risk that the borrower does not fully pay back the amount borrowed. In order to minimize that risk, the lender may consider many factors. One of these factors is the borrower's borrowing base. A borrowing base is the value of a collection of the borrower's assets, such as inventory, accounts receivable, etc. that meet particular criteria specified by the lender. The borrower may submit a list of assets to the lender. These assets may be considered as collateral with regard to the loan. However, the lender should determine that such collateral actually meets the specific criteria specified by the lender. If the collateral does not meet the criteria, then it would be considered ineligible and should not be considered by the lender in the above determination of the borrowing base.

Determining whether collateral is eligible or ineligible has conventionally been a manual process. In a manual process, the lender may evaluate each line of the borrower's list of assets visually and determine which assets are eligible collateral and which assets are ineligible collateral. This process can be time consuming, tedious, and prone to mistakes. It would be advantageous to have a system that reduces or eliminates the drawbacks of the conventional process.

### SUMMARY

In light of the above, it would be beneficial to provide a system and a method that determines whether collateral is eligible or ineligible and calculates ineligible collateral. Further, it would be beneficial to provide a system and a method that allows the lender to define and apply different criteria, rules, definitions, exceptions, etc. for different clients, inventory, invoices, debtors/vendors, etc. in determining and calculating ineligible collateral.

Therefore, aspects of this disclosure relate to a computer for determining and calculating ineligible collateral which includes a processor and memory storing computer executable instructions that, when executed, cause the computer to perform a method for determining and calculating ineligible collateral, by receiving data relating to assets or collateral of a client and determining and calculating ineligible collateral based on the data by applying one or more rules or definitions regarding ineligible collateral to the data. The rules and definitions applied to the collateral are variable based on a particular client to which the data relates.

According to further aspects of the disclosure, the computer is configured to receive client data relating to assets or collateral of a client, search the client data for relevant data, extract the relevant data and create a summary of the relevant data and determine and calculate ineligible collateral by applying one or more rules or definitions regarding ineligible collateral to the relevant data in the summary.

Additional aspects of the disclosure relate to a computer assisted method for determining and calculating ineligible collateral which includes electronically receiving data relating to assets or collateral of a client and using a computer to determine and calculate ineligible collateral based on the data. The step of using a computer to determine and calculate ineligible collateral includes causing the computer to apply one or more rules or definitions regarding ineligible collateral to the data wherein the rules and definitions applied to the collateral are variable based on a particular client to which the data relates. The computer is configured to store the rules and definitions.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 is a flowchart of an illustrative example of a method for determining and calculating ineligible collateral according to at least one aspect of the present disclosure;

FIG. 3A shows an illustrative embodiment of a Detailed Extraction Template for Accounts Receivable (A/R) according to one aspect of this disclosure;

FIG. 3B shows an illustrative embodiment of a Detailed Extraction Template for a client's address according to one aspect of this disclosure;

FIG. 3C shows an illustrative embodiment of a Detailed Extraction Template for inventory according to one aspect of this disclosure;

FIG. 4A shows a screen shot of an illustrative embodiment for creating a client record according to one aspect of this disclosure;

FIG. 4B shows a screen shot of an illustrative embodiment for creating a client record by searching for and retrieving data from a related database or system according to an aspect of this disclosure;

FIG. 4C shows a screen shot of an illustrative embodiment for a report upload screen through which the user may select the Client Source Report by searching for it in the system or related databases and systems of the lender according to such an aspect of this disclosure;

FIG. 5A shows a screen shot of an illustrative embodiment for choosing a client record by searching the system according to an aspect of this disclosure;

FIG. 5B shows a screen shot of an illustrative embodiment for choosing a particular period of the client record according to aspect of this disclosure;

FIG. 6A shows a screen shot of an illustrative embodiment for defining aging categories for the A/R of a client according to an aspect of this disclosure;

FIG. 6B shows a screen shot of an illustrative embodiment for defining aging categories for the A/P of a client according to an aspect of this disclosure;

FIG. 6C shows a screen shot of an illustrative embodiment for defining categories for the Inventory of a client according to an aspect of this disclosure;

FIG. 7A shows a screen shot of an illustrative embodiment for combining A/R debtors according to an aspect of this disclosure;

FIG. 7B shows a screen shot of an illustrative embodiment of a search feature for searching A/R debtors for combining according to an aspect of this disclosure;

FIG. 8A shows a screen shot of an illustrative embodiment for combining A/P vendors according to an aspect of this disclosure;

FIG. 8B shows a screen shot of an illustrative embodiment of a search feature for searching A/P vendors for combining according to an aspect of this disclosure;

FIG. 9 is a screen shot of an illustrative embodiment for setting client specific rules and definitions for ineligible collateral according to an aspect of this disclosure;

FIG. 10A is a screen shot of an illustrative embodiment for setting an ineligible hierarchy list according to an aspect of this disclosure;

FIG. 10B is a screen shot of an illustrative embodiment for setting invoice specific ineligibles in an ineligible hierarchy list according to an aspect of this disclosure;

FIG. 10C is a screen shot of an illustrative embodiment of a list of invoice specific ineligibles from which specific ineligibles can be chosen;

FIG. 10D is a screen shot of an illustrative embodiment for setting debtor specific ineligibles in an ineligible hierarchy list according to an aspect of this disclosure;

FIG. 10E is a screen shot of an illustrative embodiment of a list of debtor specific ineligibles from which specific ineligibles can be chosen;

FIG. 10F is a screen shot of an illustrative embodiment for setting system specific ineligibles according to an aspect of this disclosure;

FIG. 10G is a screen shot of an illustrative embodiment for summarizing a client specific ineligible hierarchy according to an aspect of this disclosure;

FIG. 11A is a screen shot of an illustrative embodiment for naming or defining the ineligibles for a particular client according to an aspect of this disclosure;

FIG. 11B is a screen shot of an illustrative embodiment for searching for a particular invoice according to an aspect of this disclosure;

FIG. 11C is a screen shot of an illustrative embodiment for searching for a particular debtor according to an aspect of this disclosure;

FIG. 11D is a screen shot of an illustrative embodiment for defining debtor specific rules for aging categories of debtors of a particular client according to an aspect of this disclosure;

FIG. 11E is a screen shot of an illustrative embodiment for defining debtor specific rules for concentration percentage of debtors of a particular client according to an aspect of this disclosure;

FIG. 11F is a screen shot of an illustrative embodiment for matching receivable accounts and payable accounts where the accounts relate the same company or entity and the possibility of offset exists according to an aspect of this disclosure;

FIG. 12A is a screen shot of an illustrative embodiment for re-aging client data according to an aspect of this disclosure;

FIG. 12B is a screen shot of an illustrative embodiment of client data that has been re-aged according to an aspect of this disclosure;

FIG. 13 is a screen shot of an illustrative embodiment showing a collateral summary according to an aspect of this disclosure;

FIG. 14 is a diagram which illustrates aspects of the system for determining and calculating ineligible collateral and the interactions between the lender, the user of the system and the client; and

FIG. 15 is a diagram which illustrates aspects of the system and the interactions between the system and related systems and databases.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

As discussed above, when a lender is determining whether to lend money to a borrower (e.g., a client of the lender, hereinafter “client”), the client may be required to submit information to the lender regarding the client's assets in order for the lender to determine whether to make the loan and, if so, the amount the lender would be willing to lend to the client. For example, the information the client submits can be in the form of a report. The report may include information about one or more of a client's Accounts Receivable (A/R), the client's Accounts Payable (A/P), the client's Inventory or the client's Address, as well as any other relevant information.

The lender may evaluate the information in the reports to determine whether the assets are eligible or ineligible collateral. However, the clients might not submit the reports in a standardized format. For example, different reports may be in different electronic formats and/or may have different layouts, different types of information, etc. Therefore, aspects of a system according the present disclosure relate to identifying, interpreting and extracting the relevant data from the report; transforming the data, and storing the data in a database of the system or a related database or system.

Additionally, whether collateral is considered eligible or ineligible may depend on the particular client (e.g., the lender may have a different criteria for each different client). Therefore, determining whether collateral is eligible or ineligible depends on the particular criteria, rules, definitions, exceptions, etc. specified by the lender for each client, invoice, inventory, debtor/vendor, etc. Therefore, aspects of the present disclosure relate to a system that allows the user to define different criteria, rules, definitions, exceptions, etc. for the different clients, invoices, inventory, debtors/vendors, etc.

Further, aspects of the present disclosure relate to a system that uses the relevant information extracted from a client report and the different criteria, rules, definitions, exceptions, etc. defined by the user for the different clients, invoices, inventory, debtors/vendors, etc. to determine and calculate ineligible collateral.

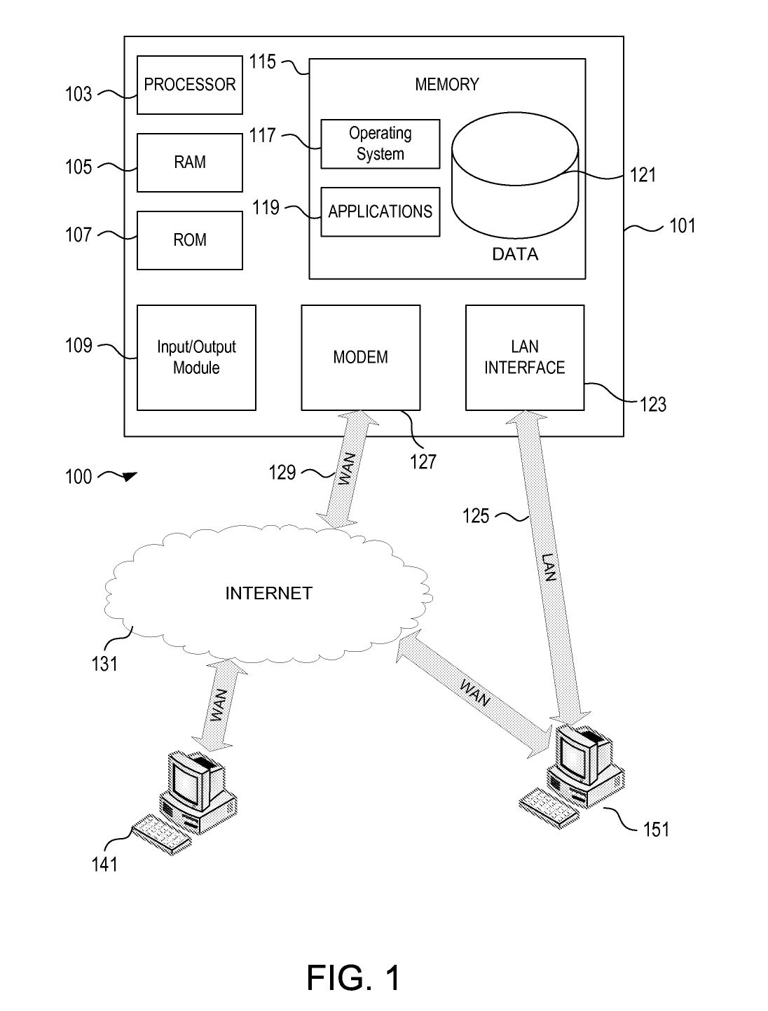

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

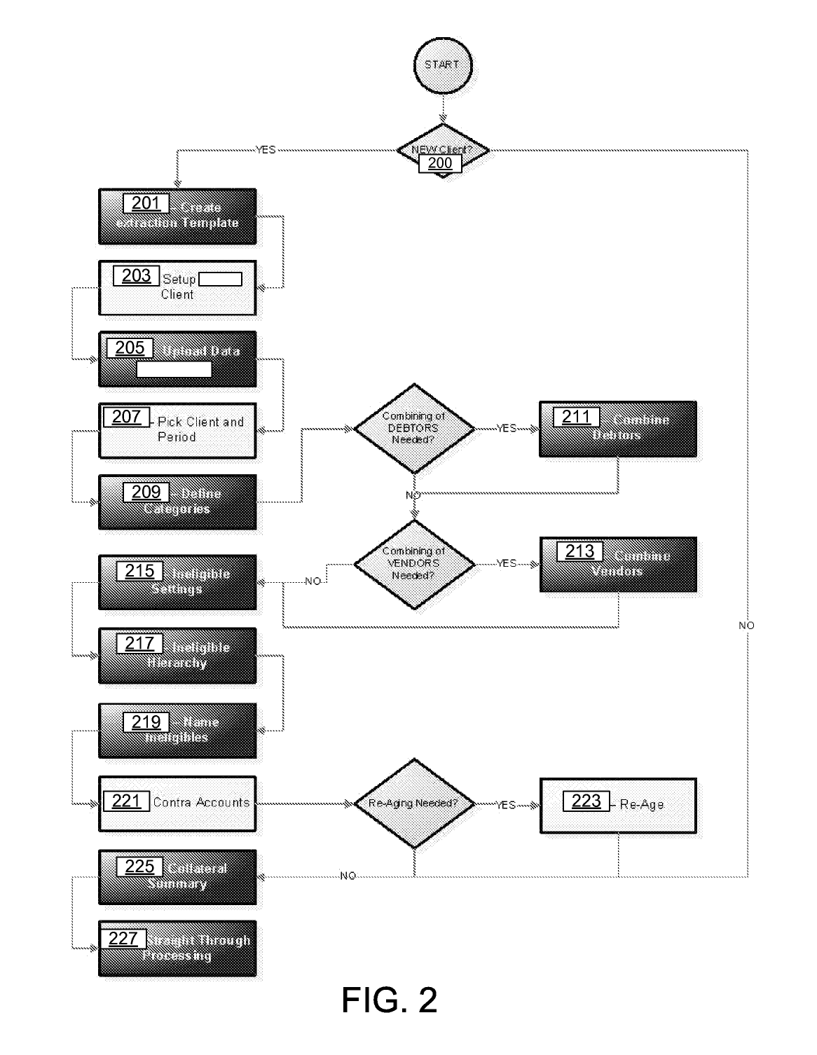

FIG. 2 illustrates a flow chart which demonstrates illustrative aspects of the system and method for determining and calculating ineligible collateral. Initially, it is noted that the system for determining and calculating a client's ineligible collateral may be an electronically based system, such as a web-based application. For example, the system may include a computer (such as described above), a network of computers, software that configures a computer to perform the below described features, etc. A user may access the system (e.g., by logging onto the system with a user name and password). The flow chart of FIG. 2 is one example of steps the user might follow once the user has accessed the system in order to allow the system to determine and calculate a client's ineligible collateral in accordance with one or more aspects of the present disclosure.

Step 200 includes determining if the client is a new client to the system (i.e., if the client has ever been processed in the system). For example, the system may include a module that configures the system to determine if the client is a new client to the system. If the client is a new client, then the user proceeds to Step 201. If the client is not a new client, then the user proceeds to Step 225.

As seen in FIG. 2, if the client is a new client, Step 201 includes creating one or more Detailed Extraction Templates for the system. For example, the system may include a module that configures the system to create one or more Detailed Extraction Templates for the system. As discussed above, clients must submit information regarding their assets such as inventory or accounts receivable, etc. Such information may be in a report, such as a Client Source Report. For example, a client's A/R, a client's A/P, a client's inventory or a client's address may each be a separate Client Source Report. It is noted that the Client Source Reports may already be stored in a related database or system of the lender (e.g., the Client Source Reports may be stored in different databases throughout a bank). Therefore, the user may use the system to electronically retrieve the Client Source Report from a related database.

Step 201 includes indentifying what type of Client Source Report (e.g., a client's A/R) has been submitted and creating a corresponding Detailed Extraction Template for that Client Source Report. For example, the system may include a module that configures the system to identify what type of Client Source Report has been submitted and create a corresponding Detailed Extraction Template. It is noted that creating the Detailed Extraction Template for that Client Source Report may simply involve pulling this template from a database within the system. According to one aspect of this disclosure, there may be at least four different types of Detailed Extraction Templates, including a Detailed Extraction Template for each of: Accounts Receivable (A/R), Accounts Payable (A/P), address and inventory. The Detailed Extraction Template may contain different fields depending on the Client Source Report to which it corresponds. For example, a Detailed Extraction Template for A/R may contain different fields than a Detailed Extraction Template for Inventory.

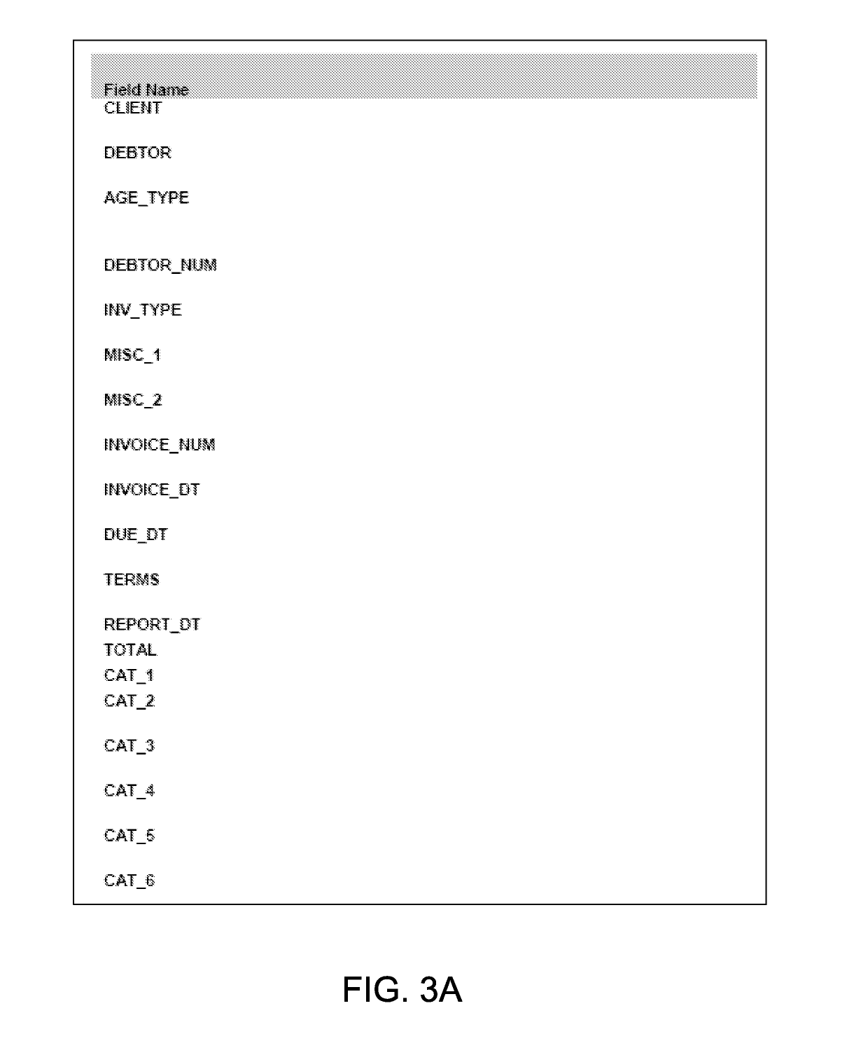

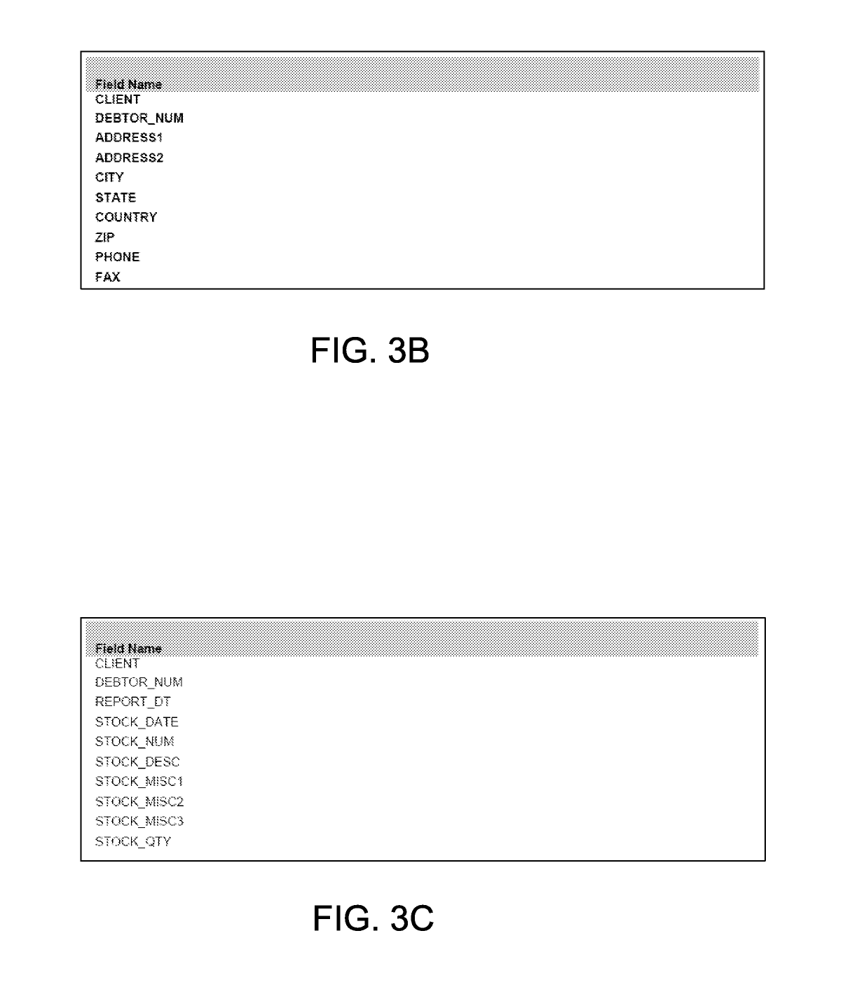

FIG. 3A shows an illustrative embodiment of a Detailed Extraction Template for an A/R according to one aspect of this disclosure. As seen in FIG. 3A, the fields of a Detailed Extraction Template for an AIR may include: Client Name, Debtor Name, Age Type (i.e., whether the aging spreads (described below) are based on Invoice date or Past Due date), Type of Invoice, Miscellaneous information, Invoice Number, Invoice Date, Due Date, Terms, Report Date, Total (i.e., the total amount owed by the debtor), the actual aging spreads (e.g., the first aging spread, second aging spread, etc.). It is noted that the Detailed Extraction Template for an A/P may be substantially the same as Detailed Extraction Template for the A/R except for vendor information being substituted in place of the debtor information.

FIG. 3B shows an illustrative embodiment of a Detailed Extraction Template for a client's address according to one aspect of this disclosure. As seen in FIG. 3B, the fields in a Detailed Extraction Template for a client's address may include: Client Name, Debtor Number, address information including: street, city, state, country, zip code, phone and fax numbers.

FIG. 3C shows an illustrative embodiment of a Detailed Extraction Template for a client's inventory according to one aspect of this disclosure. As seen in FIG. 3C, the fields in a Detailed Extraction Template for a client's inventory may include: Client Name, Debtor's Name, Report Date, and information about the inventory such as, stock date (i.e., date of the inventory), Stock Description (i.e., description of the inventory), Stock Number (a unique number for indentifying the inventory), Stock Quantity (e.g., the amount of the inventory), Stock Total (e.g., the total amount of the inventory), and Stock Value (i.e., the value of the inventory). The above described Detailed Extraction Templates serve as a basis for processes that follow and may be stored in the system for later use.

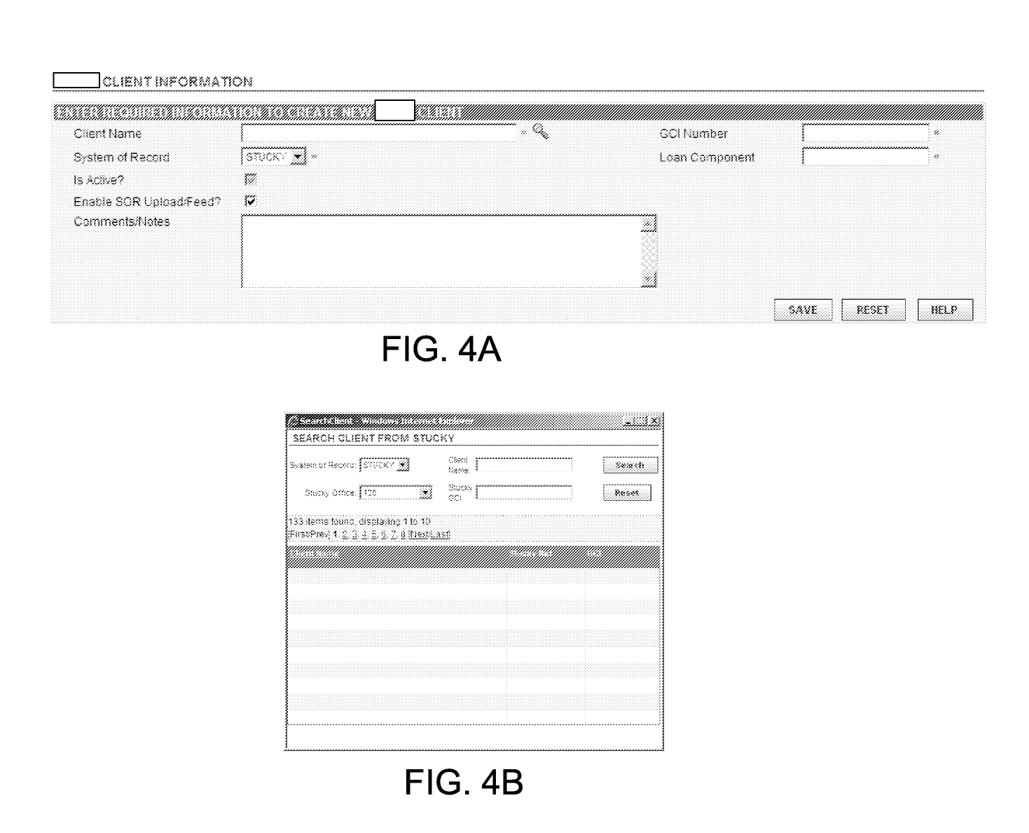

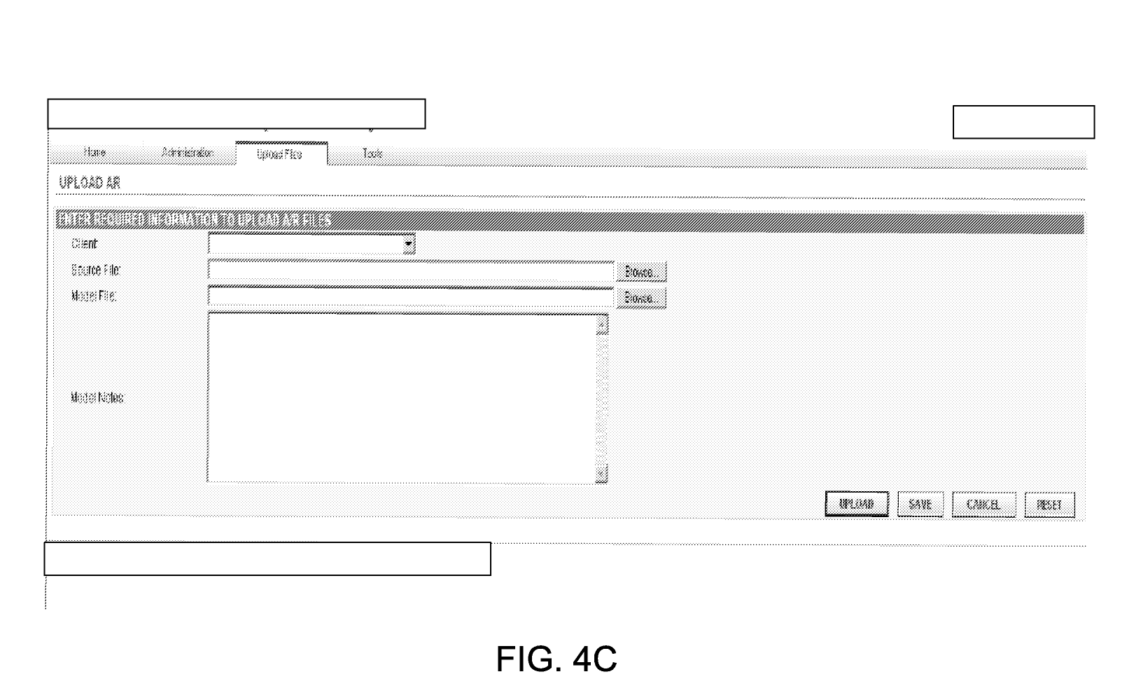

Step 203 includes creating a client record for the system. For example, the system may include a module that configures the system to create a client record for the system. FIG. 4A shows a screen shot of an illustrative embodiment for creating a client record according to one aspect of this disclosure. As seen in FIG. 4A, the information needed to create a client record may include: Client Name, System of Record (i.e., the system from which the client information is originating or should be stored), a unique client number (e.g., a GCI number), Loan Component (e.g., the loan for which the ineligible collateral is being determined and calculated), whether the client is an active client, whether to the send the data to another system of record (e.g., “Enable SOR Upload/Feed?”); and any comments or notes about the client that the user may wish to add). The user may create the client record by populating the following fields by either entering the information manually or pulling the information from a related database or system to which the system is associated (e.g., other databases or systems within the lender). In the later case, the user may create the client record by searching related databases or system for that client, and then selecting the particular client and pulling (i.e., electronically retrieving) the relevant information from that related database or system. FIG. 4B shows a screen shot of an illustrative embodiment for creating a client record by searching for and retrieving data from a related database or system according to such an aspect of this disclosure.

Step 205 includes uploading the client data (i.e., data relating to assets or collateral of a client, such as the Client Source Report) and the Detailed Extraction Template into the system. For example, the system may include a module that configures the system to receive such client data. The user may access the report upload screen and select the Client Source Report (e.g., A/R, A/P, Inventory, Address) by searching for it in the system or related databases and systems of the lender. FIG. 4C shows a screen shot of an illustrative embodiment for a report upload screen through which the user may select the Client Source Report by searching for it in the system or related databases and systems of the lender according to such an aspect of this disclosure. For example, the report upload screen may include a function for searching for all Client Source Reports under a particular client name. Once found, the user may upload the particular Client Source Report to the system. A similar process may be used to upload the corresponding Detailed Extraction Template. Once the Client Source Report and the Detailed Extraction Template have been uploaded and stored in the system, the system may perform an Extract Transform and Load (ETL) process in which the system may indentify data in the Client Source Report that relates to the fields in the corresponding Detailed Extraction Template.

As noted above, the Client Source Reports might not have been provided to the bank in a standardized format. For example, different clients may submit Client Source Reports that are in different formats (e.g., PDF format, a text file, etc.); have different layouts; different types of data; etc. Therefore, software is used to search a Client Source Report and extract relevant data from the Client Source Report (i.e., “mine” the relevant data) regardless of the format in which the Client Source Report was originally submitted. It is noted that the process of “mining” the relevant data from the Client Source Report may utilize software such as “Datawatch MonarchPro” available from Datawatch Corporation of Chelmsford, Mass. Once the relevant data has been “mined”, the system may create a summary of the data. The summary includes data corresponding to some or all of the fields from the corresponding Detailed Extraction Template. The summary may provide the relevant data in a standardized format. This summary may also be stored in the system database or a related database or system. According to some aspects of this disclosure, an email may be sent to the user once this process is completed.

It is noted that the above steps 200, 201, 203, 205 may be completed without immediately continuing on to the rest of the steps in the flow chart. For example, different clients, different Client Source Reports, different Detailed Extraction Templates, etc. may each be processed according to the above steps without continuing on to the subsequent steps shown in the flow chart and described below. Of course, as stated above, these documents and files serve as the basis for determining and calculating the client's ineligible collateral. Therefore, at some point the subsequent steps may be taken to determine and calculate the ineligible collateral.

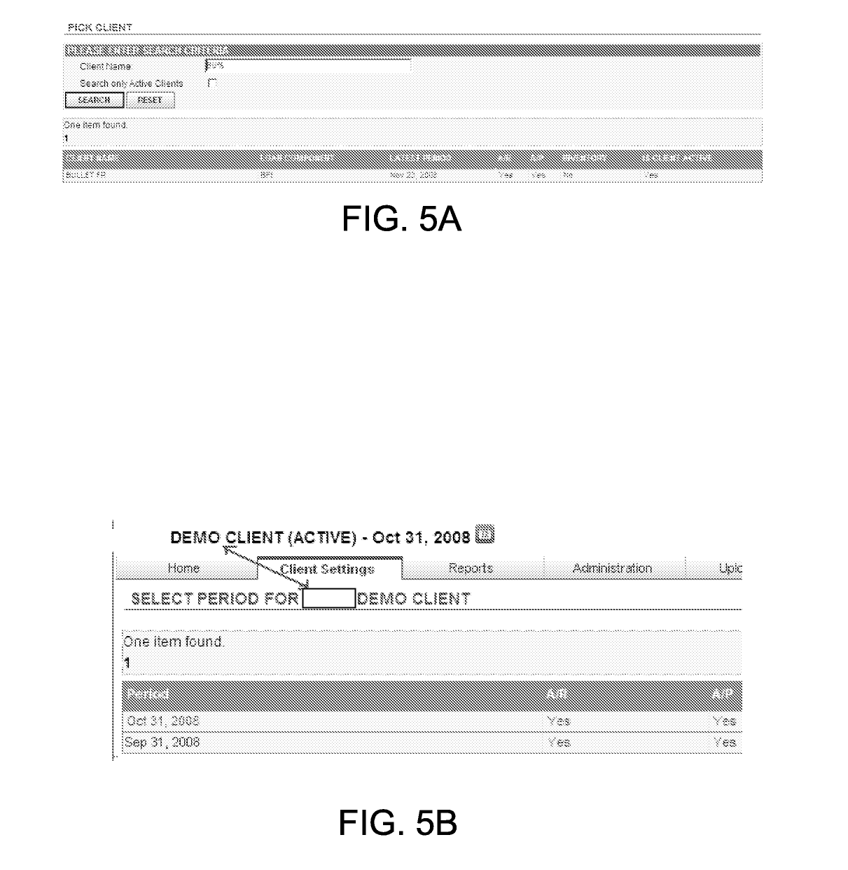

Step 207 includes picking a client for which the user wishes to determine and calculate the ineligible collateral. For example, the system may include a module that configures the system to pick a client for which the user wishes to determine and calculate the ineligible collateral. FIG. 5A shows a screen shot of an illustrative embodiment for choosing a client record according to such an aspect of this disclosure. As seen in FIG. 5A, according to aspects of this disclosure, the user may type in a few letters of the client name and request a search to locate a client record in the system or in one of the related databases or systems of the lender.

Each client may have more than one relevant time period for which the user wants to determine and calculate the ineligible collateral. For example, clients may submit Client Source Reports monthly or quarterly. Therefore, Step 207 may also include picking a particular period (e.g., a month or a quarter) for which the user wishes to determine and calculate the ineligible collateral of that client. For example, once the user selects the particular client, the system may filter available periods for that selected client. The system may display those available periods and whether the periods contain a summary and what type of summary (e.g., A/R, A/P, etc.). FIG. 5B shows a screen shot of an illustrative embodiment for choosing a particular period for the client record according to such an aspect of this disclosure. As seen in FIG. 5B, the system may list both the available time periods from which the user can select and also the types of summaries available.

Step 209 includes providing the user with the opportunity to define aging categories used in determining and calculating the client's ineligible collateral. For example, the system may include a module that configures the system to provide the user with the opportunity to define and store aging categories used in determining and calculating the client's ineligible collateral. The system can provide different aging categories for the A/R or A/P and the user has the ability to define those aging categories. Aging categories relate to the amount of the time that items in the A/R or A/P have been outstanding. For example, with regard to A/R, in some cases, if a particular receivable has been outstanding for over a year, then it is likely that receivable will not be collected by the client. Hence, such an receivable should be considered ineligible collateral and, hence, not be included in determining items such as a client's borrowing base, the amount of money the lender should lend the client, etc. The ability to define aging categories may be particular advantageous for a lender who has clients in various different fields. For example, in some fields, debts outstanding for over 30 days may be considered past due (and, therefore, less likely to be collected by the client), while in other fields, debts over 100 days may still be considered current (and, therefore, still likely to be collected by the client). In other words, for one client, a debt outstanding for over 100 days may be ineligible collateral, while for another client a debt outstanding for over 100 days may be eligible collateral. This feature of the system allows the user to define the aging categories for each client and, therefore, customize the ineligible collateral determination and calculations for a particular client.

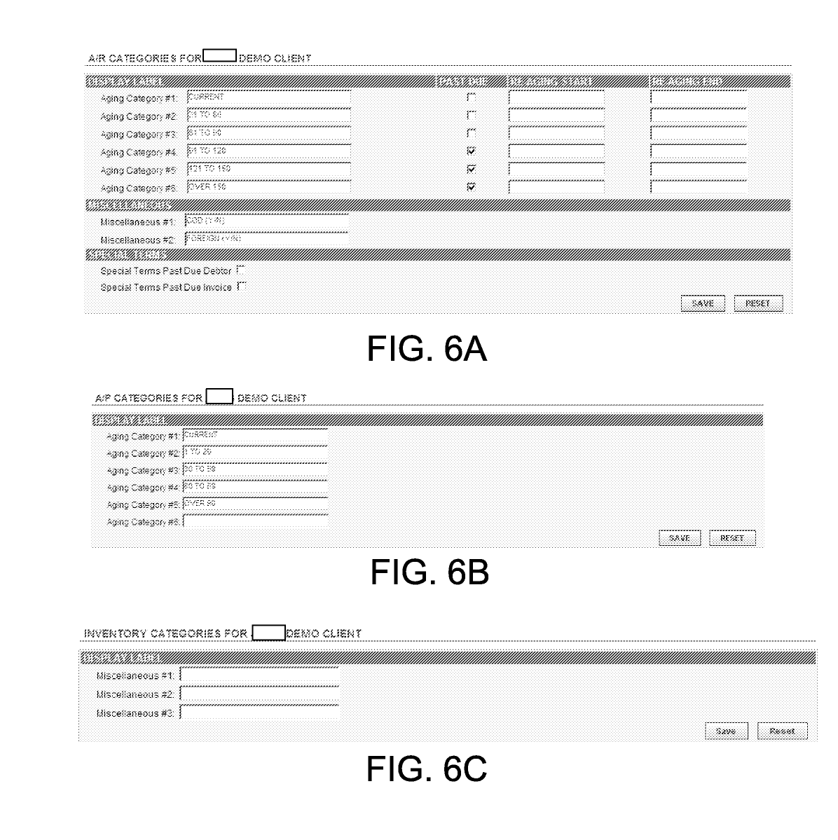

FIG. 6A shows a screen shot of an illustrative embodiment for defining aging categories for the A/R of a client according to such an aspect of this disclosure. As seen in FIG. 6A, the first aging category is defined as current, the second aging category is defined as 31-60 days, the third aging category is defined as 61-90 days, the fourth aging category is defined as 91-120 days, the fifth aging category is defined as 121-150 days, and the sixth aging category is defined as over 150 days.

Further, as seen in FIG. 6A, the system may include a module that configures the system to provide the user the ability to define (e.g., by marking with the checkmark) any of the aging categories as past due. Past due is used to indicate accounts which have been outstanding for an unreasonable period, and therefore, are considered ineligible. By marking a particular aging category as past due the user may cause the system to automatically interpret such debts/invoices therein as ineligible collateral.

Generally, if payment has not been received at the end of three billing cycles (e.g., after 90 days for net 30 day terms; after 21 days for net 7 day terms) the debt is considered past due and, therefore, ineligible collateral. However, as described above, the point when a receivable is considered past due may vary depending on the industry that it is associated with. Therefore, providing the user the ability to individually define, at the client level, which particular ageing categories are considered past due provides flexibility that is advantageous for a system designed to handle different clients.

Further, as seen in FIG. 6A, the system may include a module that configures the system to provide the user the ability to re-age the A/R aging categories by defining the specific time period. Re-aging allows the user the ability to update the information based on that specific time period. For example, the user can use the invoice date as the “re-aging start date” and the current date as the “re-aging end date”. By recalculating the aging categories using this time period (such a recalculation is done at a later step in this process based on the time period defined at this step), the client can ensure the information provided in the Client Source Report is current. For example, if the Client Source Report was created one year ago, then that information is no longer current. By re-aging the information provided from that original Client Source Report based on the time period of the invoice date to the current date, the system can determine how many days it actually has been from the invoice date to the current date. Therefore, the system will have accurate data with which to determine what collateral is ineligible. The user may use other time periods also. For example, instead of the invoice date as the “re-aging start date”, the user may use the due date as the “re-aging start date.”

Further, as seen in FIG. 6A, the system may includes a module that configures the system to provide the user the ability to specify additional information about the receivable. For example, the user may define whether the receivable is a COD or a foreign debt and, hence, perhaps uncollectable. Therefore, by providing these fields, the system provides the user the opportunity to designate the account receivable as ineligible collateral and, therefore, the system may automatically interpret the receivable as ineligible collateral regardless of the aging category.

Examples of ineligible categories for receivables in the system may include: Foreign Debt (i.e., receivables owned by a company located outside the US), Unbilled Receivables (i.e., goods that have been sold or services rendered but no invoice yet issued); Affiliate, Inter-company, Subsidiary Accounts (i.e., receivables that are owed by any company owned or operated by the client); Service/Finance Charges (i.e., debit balances on the aging usually represent unpaid partial balances of invoices and typically arise from a dispute with an account debtor; Government Accounts; COD Accounts; Employee Accounts; Bill and Hold Receivables; Datings/Futures; Credit Card, Cash Sales, and Prepaid; Progress Billings; Retention; Progress Billings; Bankrupt/DIP; Pre-Billings and Bill and Holds; Consignment Sales; Bonded Receivable; Guaranteed Sales (i.e., sales that allow the purchaser to return the unsold goods to the seller for full credit); Security interested not perfected; Debit Memo's and Chargebacks; Credit Hold (wherein a credit hold is put on the debtor due to delinquent status or exceeding a credit limit); etc. It is noted that, of course, the system may be updated to add, remove, modify, etc. any ineligible categories.

Further, as seen in FIG. 6A, the system may include a module that configures the system to provide the user the ability to specify whether the particular debtor is a “special terms past due debtor” or whether a particular invoice is a “special terms past due invoice.” This feature of the system provides the user with the opportunity to designate the receivable as an exception to the aging category or past due marking. For example, if the debtor is known to be particularly reliable, then the aging of the debt or past due status of debt, etc. may be irrelevant and marking this category may allow the system to automatically interpret the debt as eligible collateral. The same feature applies to particular invoices if the invoice is considered a “special terms past due invoice”.

FIGS. 6B and 6C show categories for a client's A/P and a client's inventory. Both of these features are similar to the above described features, and hence will not be described again here for the sake of brevity. However, it is noted that examples of ineligible categories for inventory in the system may include: Work In Process (i.e., inventory in its raw materials stage and placed into a production stage); Offsite Inventory; Obsolete, Non-Saleable, Discontinued, Excess inventory; Slow Moving Inventory (i.e., inventory that does not move with standard frequency; slow turnover.) Consignment Inventory; Damaged or Returned Inventory; Packaging Materials/Supplies; Customized/Private Label; In-Transit Inventory; Unassembled parts (e.g., custom made to borrower specifications); Dedicated Finished Goods (e.g., finished goods manufactured for a particular customer of the Borrower, especially with the customer's name on it); etc. It is noted that, of course, the system may be updated to add, remove, modify, etc. any ineligible categories.

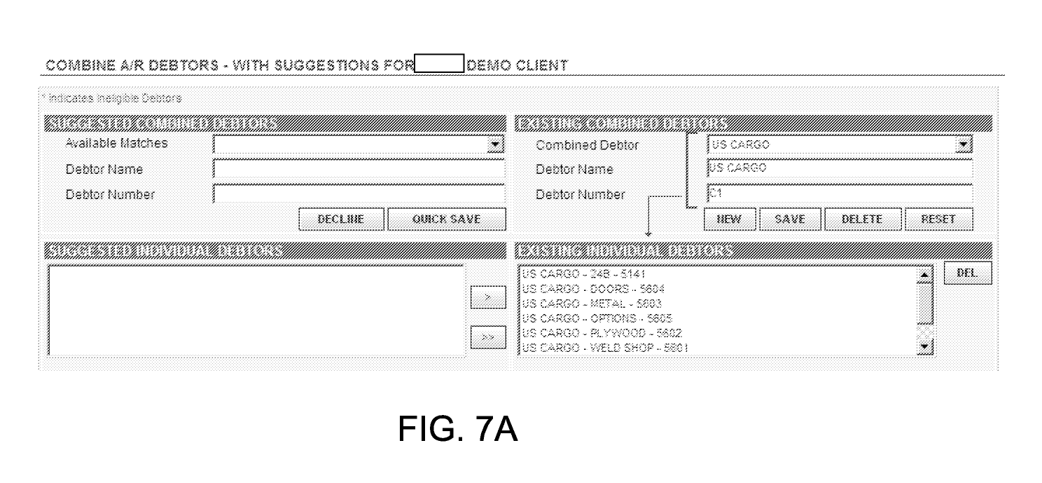

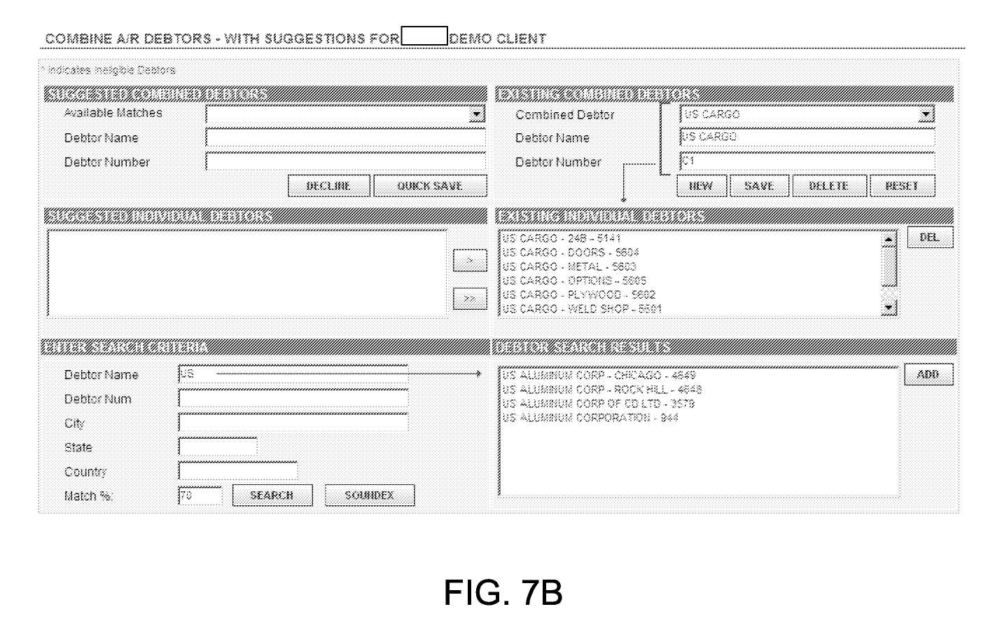

Step 211 includes that combining multiple A/R debtors into a single debtor. For example, the system may include a module that configures the system to provide the user the opportunity to combine multiple A/R debtors into a single debtor. For example, in certain cases, Client Source Reports contain A/R debtors as separate entities even though they are, in fact, the same company. For example, different branches or subsidiaries of the same company may be listed as separate debtors. This feature of the system provides the ability to combine those different branches or subsidiaries into a single debtor. FIG. 7A shows a screen shot of an illustrative embodiment for combining debtors according to such an aspect of this system. As seen in FIG. 7A, the system lists the combined debtor (e.g., US Cargo) at the upper right hand corner of the display and also lists the existing individual debtors which make up the combined debtor.

In order to aid the user in locating debtors who should be combined into a single debtor, the system includes a feature that allows the user to search for debtors that have the similar names. FIG. 7B shows a screen shot of an illustrative embodiment for such a search feature according to an aspect of this disclosure. As seen in FIG. 7B, in order to obtain a list of “like” debtors that are already listed in the system, the user may perform a search using a search term (e.g., a partial debtor name, such as “US”). The system may use the “soundex” (phonetic match) function of software available from Oracle Corporation of Redwood Shores, Calif. to identify any debtors that have similarities to the search term and suggest those debtors as debtors that may potentially be the same debtor. For example, the system may then display a list of such “like” debtors. The user can then select any debtors that should be combined and combine them into a single debtor. This feature may be particularly advantageous to the user, because the user might not be aware of other branches, subsidiaries, etc. that should be combined into a single debtor. Yet, by using this function the user will be able to identify and combine such debtors quickly and efficiently.

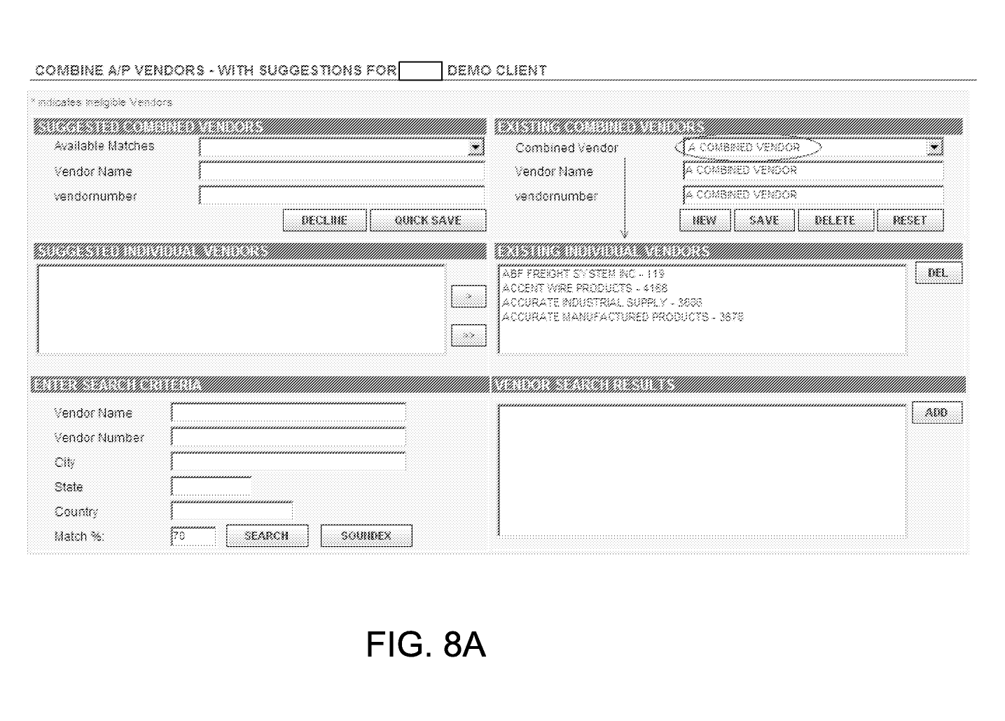

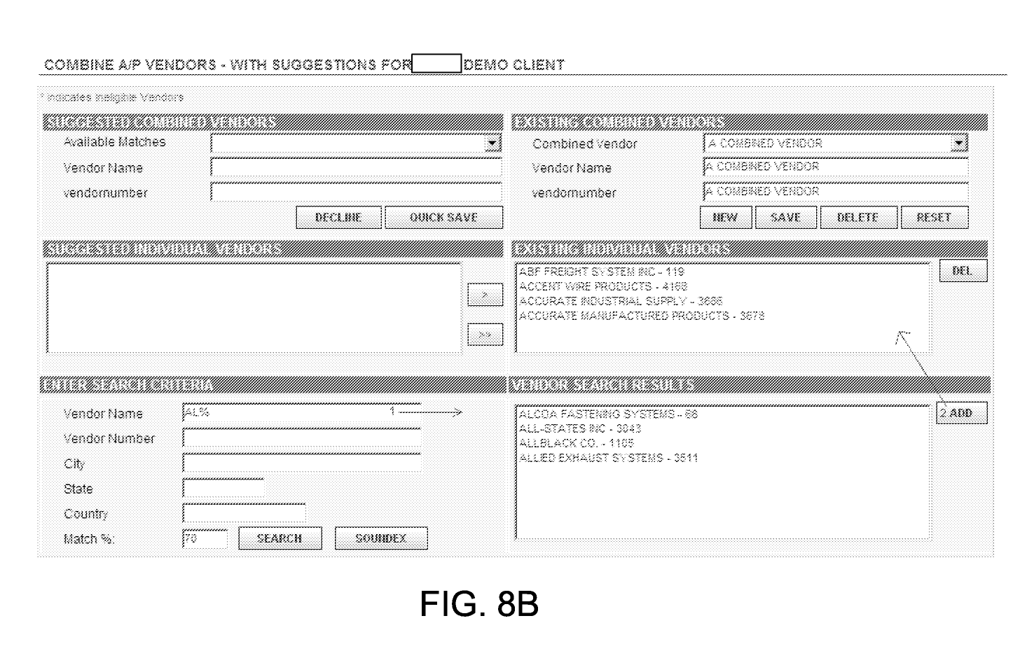

Step 213 includes combining multiple A/P Vendors into a single vendor. For example, the system may include a module that configures the system to provide the user with the opportunity to combine multiple A/P Vendors into a single vendor. FIG. 8A shows a screen shot of an illustrative embodiment for combining vendors according to such an aspect of this disclosure. FIG. 8B shows a screen shot of an illustrative embodiment for searching for vendors according to such an aspect of this disclosure. As many of the aspects of this feature are similar to the above described Step 211, further description will be eliminated for the sake of brevity.

Step 215 includes defining for each client, specific settings for ineligible categories that are to be applied to the client including limits and percentages for such system settings as concentration, cross-aging, reserves, etc. For example, the system may include a module that configures the system to provide the user with the opportunity to define and store, for each client, specific settings for ineligible categories that are to be applied to the client including, limits and percentages for such system settings as concentration, cross-aging, reserves, etc. In step 215 the user may choose a particular client as described above. Upon selecting a client, the user may set particular rules and definitions for that client regarding limits and percentages in ineligible categories such as concentration, cross-aging, reserves and other ineligible categories.

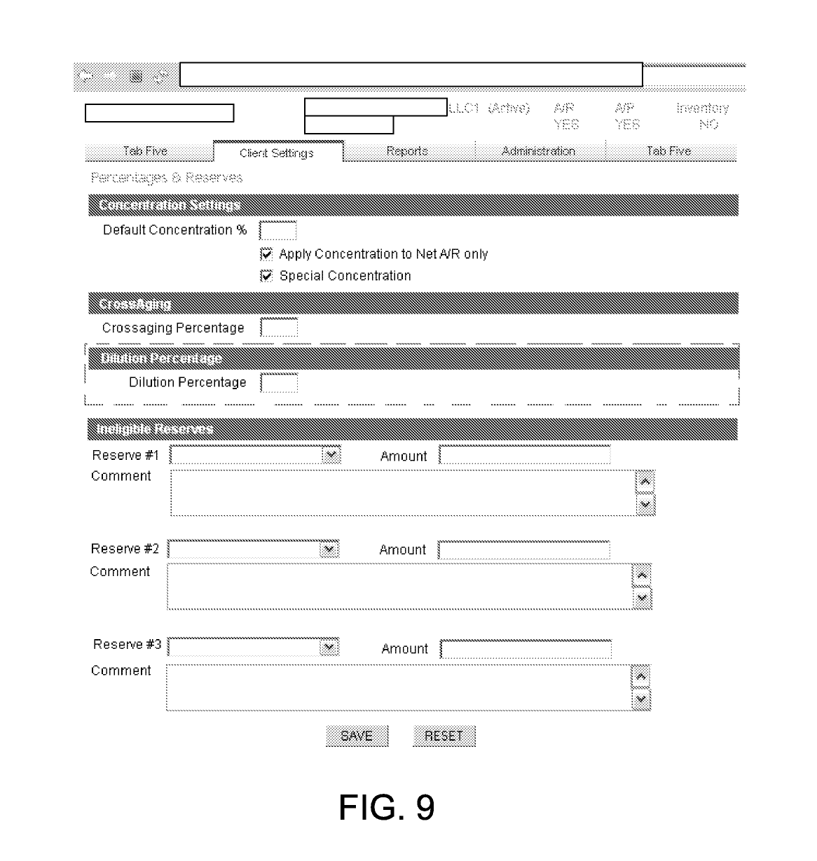

FIG. 9 is a screen shot of an illustrative embodiment for defining client specific settings for ineligible categories according to an aspect of this system. As seen in FIG. 9, the user may define the “default concentration” percentage. In regards to A/R, the term “concentration” refers to the percentage of a total amount of the A/R that is attributable to a single debtor. The gross concentration can be calculated using the following sequence:
Concentration at Gross A/R
   Is the debtor's remaining eligible A/R balance>X % of the client's total accounts receivable balance?
   If so, the debtor's balance exceeding X % is ineligible.

Concentration is relevant to a determination of ineligible collateral because if a large percentage of a client's total A/R is with one debtor, then the client may be taking a large risk that the debtor will in fact repay the debt to the client. The lender may consider such a situation too risky and, therefore, not wish to use the A/R as eligible collateral. For example, if the lender does not want more than 50% of a client's total A/R attributed to a single client, the lender may set the default concentration at 50%. In this case, if a client has an A/R wherein one debtor is responsible for 90% of a client's total A/R, then the system would automatically interpret some or all of the A/R as ineligible.

Concentration can also be determined with regard to eligible net A/R. The net eligible concentration can be calculated using the following sequence:
Concentration at Eligible (Net) A/R
   Is the debtor's remaining eligible A/R balance>X % of the client's eligible (net) accounts receivable balance?
   If so, the debtor's balance exceeding X % is ineligible.

As seen in FIG. 9, the user may be able to select “Apply Concentration to Net A/R only” and/or “Special Concentration”.

Further, as seen in FIG. 9, the user may define the “Cross-aging” percentage. Cross-aging refers to a situation wherein if a particular amount of a total debt is seriously in arrears (typically 10% up to 50%), then the debt is considered ineligible collateral. In other words, if a debtor has an outstanding debt to the client and more than a certain percentage of the total outstanding debt, is past due, then that entire debt may be considered ineligible collateral. For example, if a cross-aging limit was set at 50% and a debtor has a past due debt to the client of $500 and then later borrows another $400 from the client (which is not yet due to be repaid and, therefore, current), the past due amount is still more than 50% of the total debt of $900 and, therefore, the system would automatically interpret the total debt as ineligible collateral. The following calculation sequence can be used to calculate cross-aging:
Cross-Aging Threshold=X % (per Credit Agreement)
Is the debtor's past due balance≧X % of the debtor's total balance?
If so, the debtor's non-past due balance is ineligible.

Further, as seen in FIG. 9, the user may define the “Dilution” percentage. Dilution refers to a percentage of the total A/R (or in some cases, the total eligible collateral) that the lender will not lend on under any circumstances. For example, a lender only lend on 90% of the total A/R, simply because it is unlikely that the lender will be able to recover the entirety of the accounts receivable. Therefore, the lender may define 10% of the total A/R as a dilution limit. In this case, the system would automatically ensure that the lender will only lend a maximum of 90% of the total A/R (or in some cases, the total eligible collateral).

Further, as seen in FIG. 9, the user may enter other ineligible categories known as ineligible reserves. Ineligible reserves may refer to ineligible categories that cannot be calculated based on the information in the Client Source Report (e.g., the A/R A/P, inventory). Instead the information may come directly from the client itself or another financial report of the client's. For example, the client may inform the lender that a set amount of money is considered ineligible for a particular reason. An ineligible reserve may be chosen from a dropdown list of potential ineligibles that are already defined in the system. The user will be able to enter the amount and comments for each of the ineligible reserves. In this way the system provides the user an opportunity to enter information into the system about ineligible collateral not included in the Client Source Report. The system may use all the above described information (definitions, rules, settings, etc.) in subsequent processes (e.g., to calculate ineligible collateral).

Step 217 includes creating an ineligible hierarchy list for each client. For example, the system may include a module that configures the system to provide the user with the opportunity to create and store an ineligibles hierarchy list for each client. The ineligibles hierarchy list lists the ineligible categories and sets the order in which the ineligibles should be calculated. For example, according to one example of an ineligible hierarchy, the past due ineligibles are calculated first. Next, aging ineligibles are calculated. Next, invoice specific ineligibles are calculated in a specific order defined for the particular client. Next, debtor specific ineligibles are calculated next in a specific order defined for the particular client. Finally, system specific ineligibles (e.g., the concentration, cross-aging, etc.) calculations are calculated. It is noted that, of course, the order may be different in other embodiments.

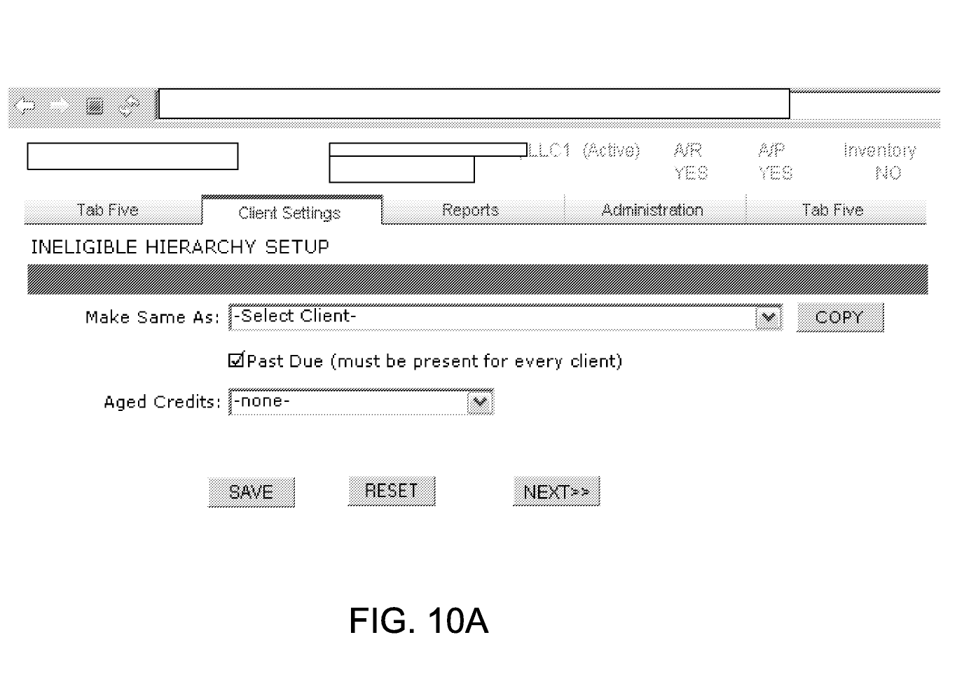

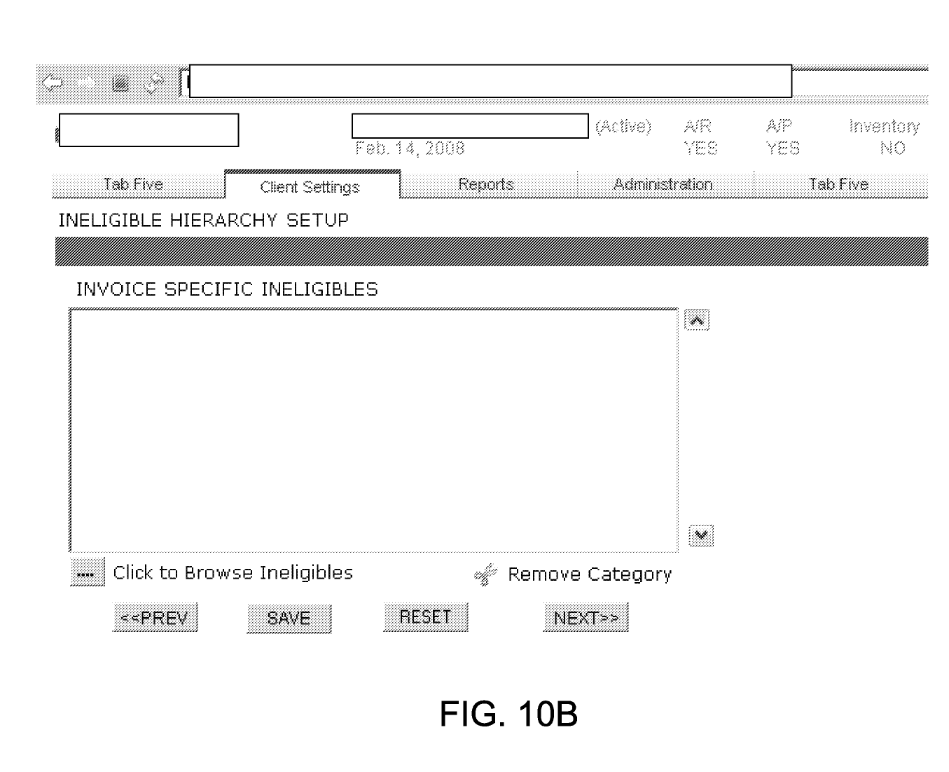

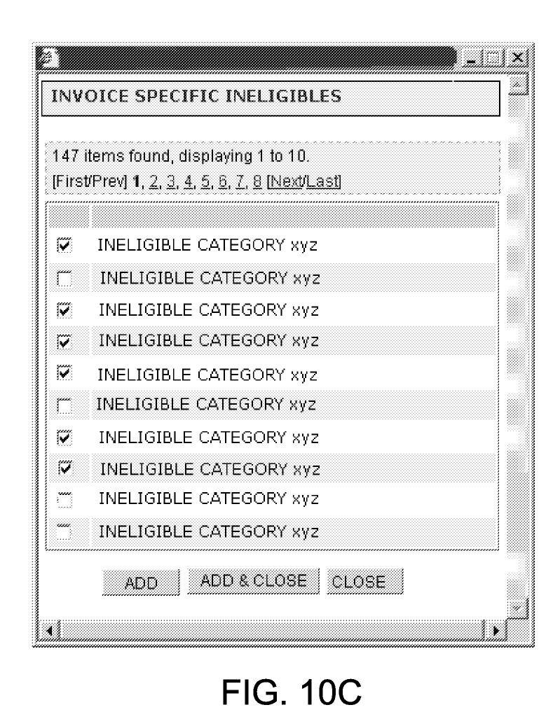

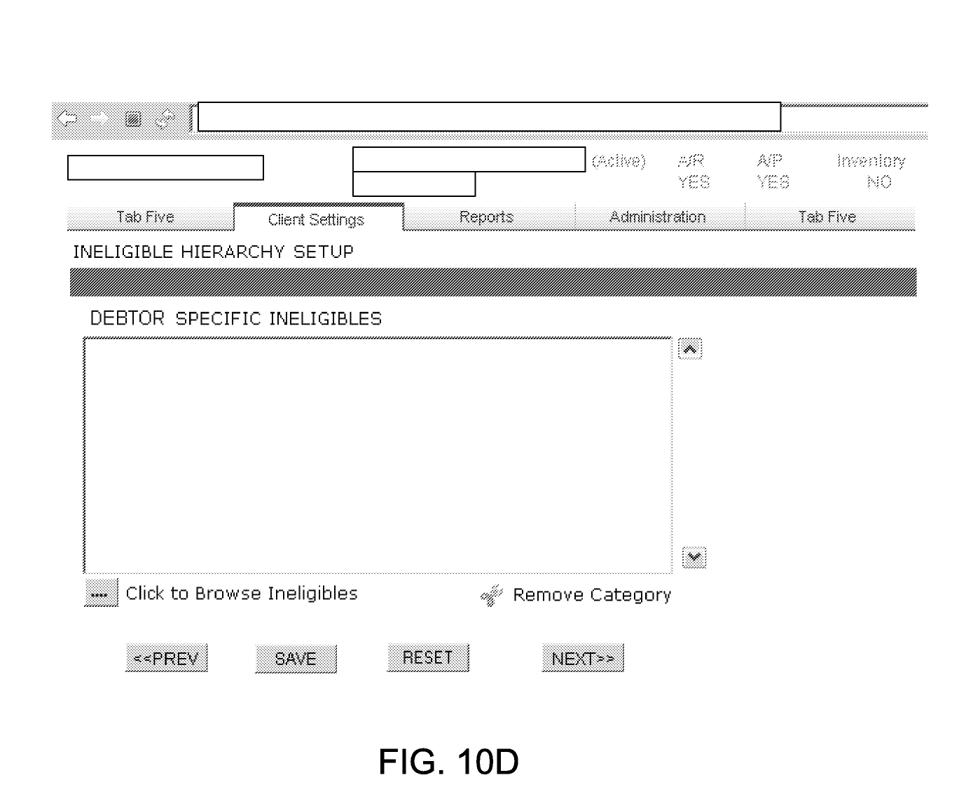

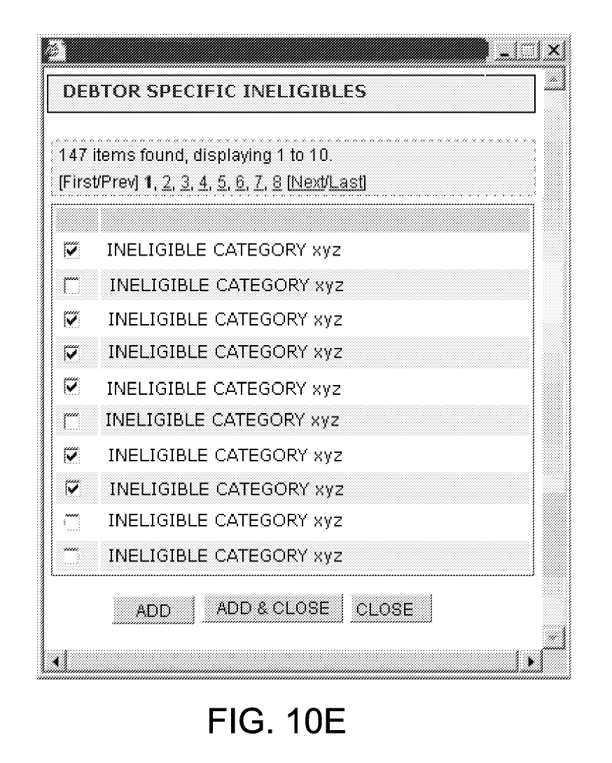

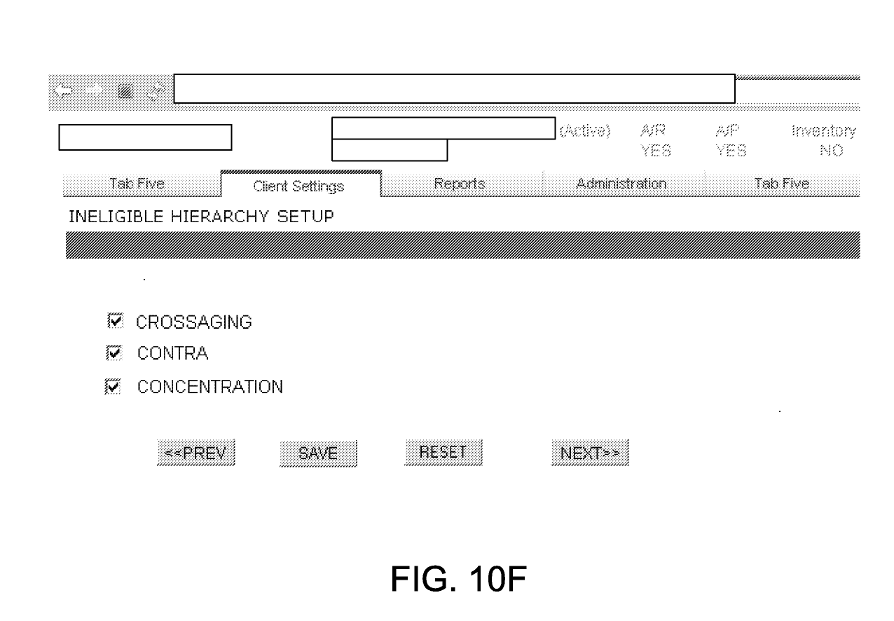

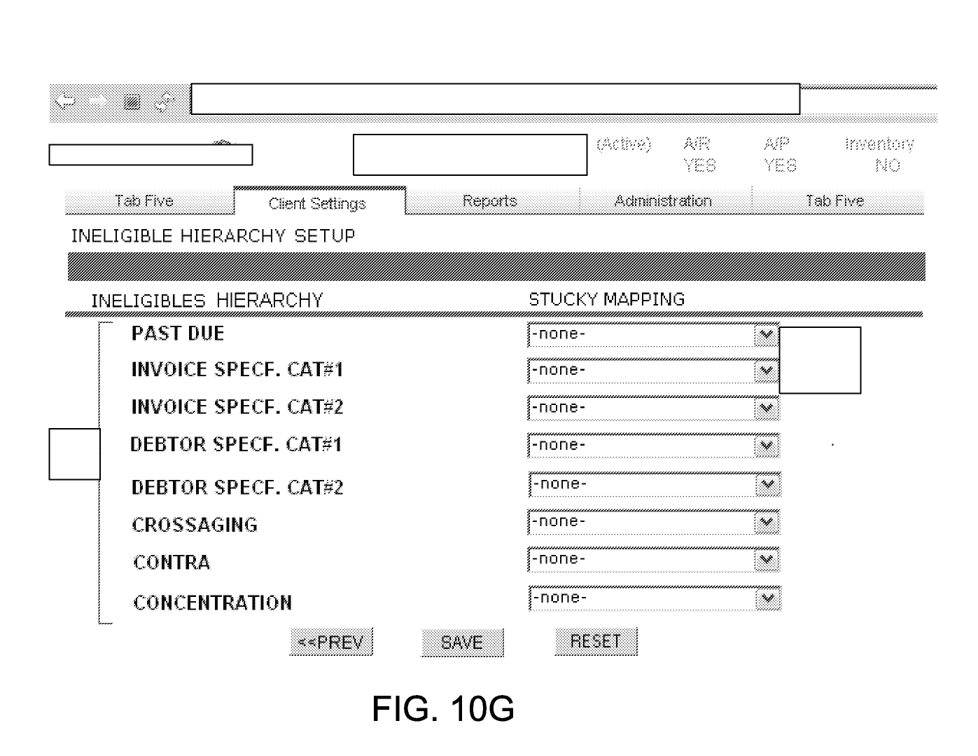

An ineligible hierarchy allows the system to perform the calculations related to the ineligible collateral in a way that is customized to the particular client. For example, FIG. 10A is a screen shot of an illustrative embodiment for setting an ineligible hierarchy list according to an aspect of this disclosure. As seen in FIG. 10A, the user may pick Past Due Accounts and/or Aged Credit in the setting the ineligible hierarchy.

The system may include a module that configures the system to provide the user with the opportunity to define and store invoice specific ineligibles for the client. This feature of the system provides the user the opportunity to pick ineligible categories into which a particular client's invoices can be classified. Further, this feature of the system provides the user the opportunity to define the order in which the ineligible categories should be analyzed. Therefore, when the system calculates the client's A/R, the system may classify the individual invoices of the client's A/R into different ineligible categories and then perform ineligible collateral calculations in the specific order defined by the user. FIG. 10B is a screen shot of an illustrative embodiment for setting invoice specific ineligibles according to an aspect of this disclosure. The user can choose the ineligible categories from a list of ineligible categories that is already in the system. For example, the user can browse the list of ineligible categories by selecting the “Click to Browse Ineligibles” feature shown in the FIG. 10B. This may cause the system to display a list of ineligible categories from which the user can choose. FIG. 10C which is a screen shot of an illustrative embodiment of such a list ineligible categories according to such an aspect of this disclosure. The user will be able to choose which particular ineligible categories should be applied for each client by selecting or deselecting ineligible categories from the list. Further, the user can move the ineligible categories up or down in the ineligible hierarchy (i.e., rank the order in which the ineligible categories are processed).

The system may include a module configures the system to provide the user with the opportunity to define and store debtor specific ineligibles for the client. In other words, this feature of the system provides the user the opportunity to pick ineligible categories into which a particular client's debtors can be classified. Further, this feature of the system provides the user the opportunity to define the order in which the ineligible categories should be analyzed. Therefore, when the system calculates the client's A/R, the system may classify the individual debtors of the client's A/R into different ineligible categories and then perform ineligible collateral calculations in the specific order defined by the user. FIG. 10D is a screen shot of an illustrative embodiment for setting debtor specific ineligibles according to an aspect of this disclosure. The user can choose the ineligible categories from a list of ineligible categories that is already in the system. For example, the user can browse the list of ineligible categories by selecting the “Click to Browse Ineligibles” feature shown in the FIG. 10D. This may cause the system to display a list of ineligible categories from which the user can choose. FIG. 10E which is a screen shot of an illustrative embodiment of such a list ineligible categories according to such an aspect of this disclosure. The user will be able to choose which particular ineligible categories should be applied for each client by selecting or deselecting ineligible categories from the list. Further, the user can move the ineligible categories up or down in the ineligible hierarchy (i.e., rank the order in which the ineligible categories are processed).

It is noted once an item (e.g., a receivable) has been determined to be ineligible, that item is excluded from the further calculations. For example, according to the hierarchy described above wherein the calculations are done at the invoice level before the debtor level, receivables that have already been determined to be ineligible at the invoice level, may be excluded from the calculations at the debtor level. In this way, the system can prevent a particular receivable from being ruled ineligible more than once and skewing the calculation of the client's ineligible collateral.

Also, in setting the ineligible hierarchy, the system provides the user the opportunity to select whether the system should perform system specific calculations of: cross-aging, contra accounts (described below), and concentration in determining the ineligible collateral. FIG. 10F is a screen shot of an illustrative embodiment for setting system specific ineligibles according to such an aspect of this disclosure.

Once the user has completed defining the ineligible hierarchy, the system may sequence the ineligible hierarchy appropriately. For example, FIG. 10G is a screen shot of an illustrative embodiment for summarizing the ineligible hierarchy for a particular client according to such an aspect of this disclosure. As seen in FIG. 10G, the system displays a summary screen showing the overall ineligible hierarchy in which the system may process the information to determine the ineligible collateral.

Step 219 includes naming or defining the ineligibles for a particular client. For example, the system may include a module that configures the system to provide the user with the opportunity to name, or define, (and store) the ineligibles for a particular client. In other words, for a particular client, the user can create and store definitions or rules about the client's: ineligible categories, aging categories, debtors/vendors, invoices, settings (e.g., concentration, etc.), etc. For example, the system may include a module that configures the system to provide the user with the opportunity to create rules or definition which classify debtors into particular ineligible categories. In other words, the system allows the user to create filters so when the system determines ineligible collateral, debtors matching the criteria of the filter are classified as ineligible. For example, the user can classify a single particular debtor as ineligible and, hence, any debt from the debtor in the A/R will be considered ineligible. This feature is advantageous because it allows the user to ability to ensure all debts from a particular debtor (e.g., a known unreliable debtor or a debtor in bankruptcy, etc.) are considered ineligible without having to tediously search for and classify each particular debt of the debtor as ineligible.

Further, the system may include a module that configures the system to provide the user with the opportunity to create rules and definitions which classify invoices into particular ineligible categories. In other words, the system allows the user to create filters so when the system determines ineligible collateral, individual invoices (e.g., receivables) matching the criteria of the filter are classified as ineligible. For example, the user can classify a single particular receivable as ineligible and, hence, it will be considered ineligible and filtered from other invoices that are eligible. This feature is advantageous because of the detailed level of specificity it provides the user, wherein individual invoices can be parsed out as ineligible for their respective individual reasons (e.g., foreign debt, COD account, etc.).

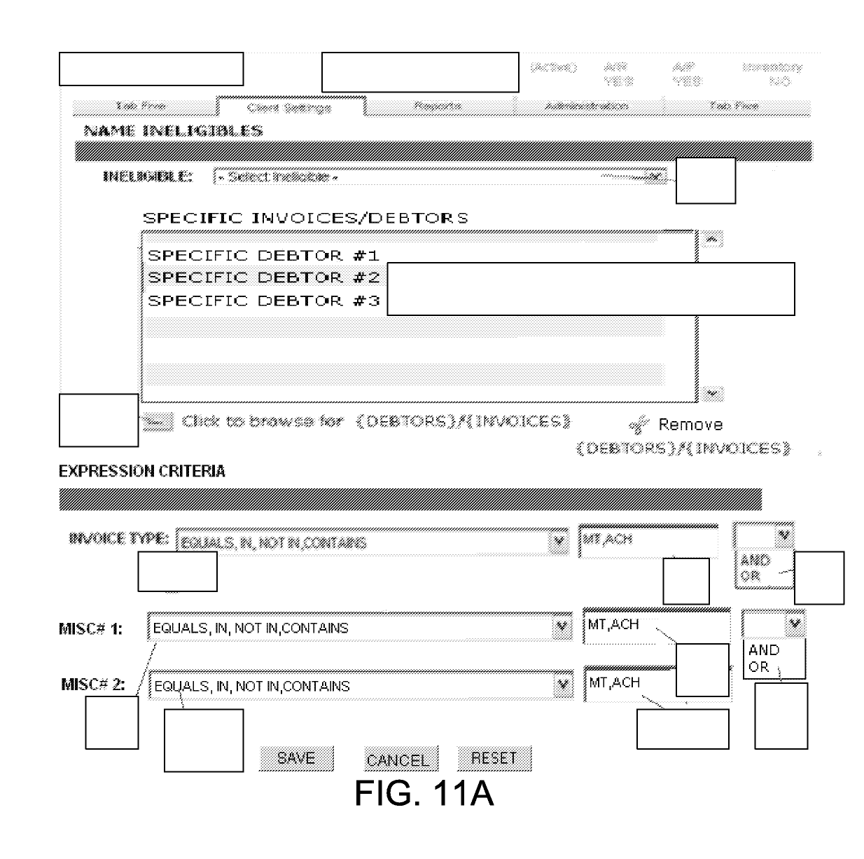

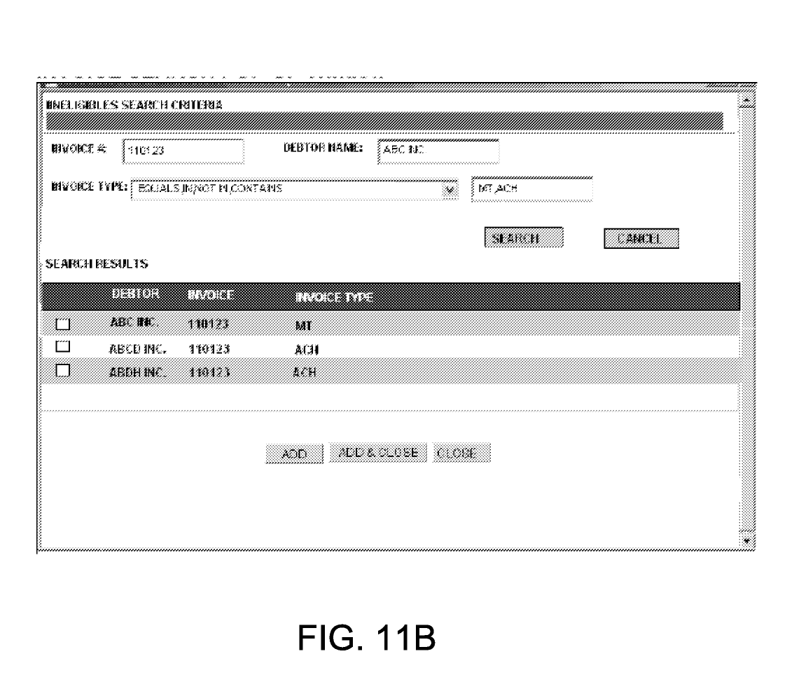

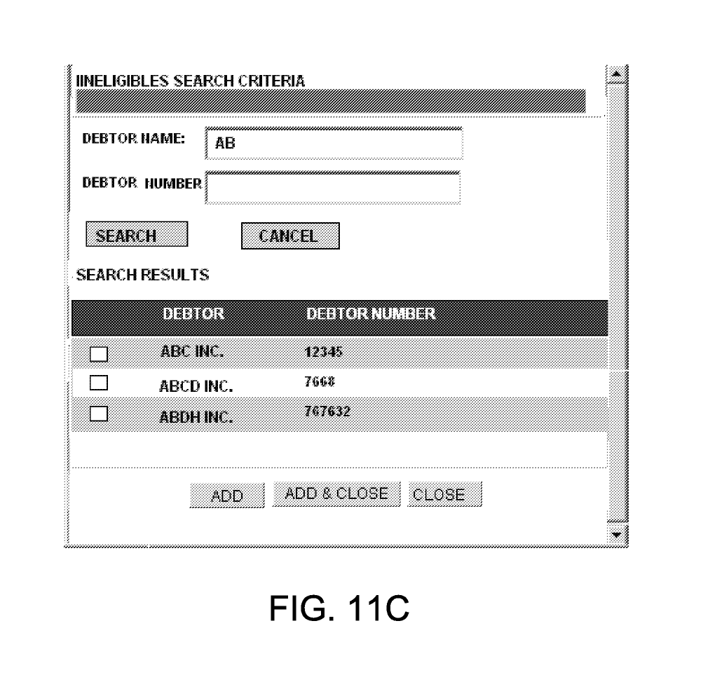

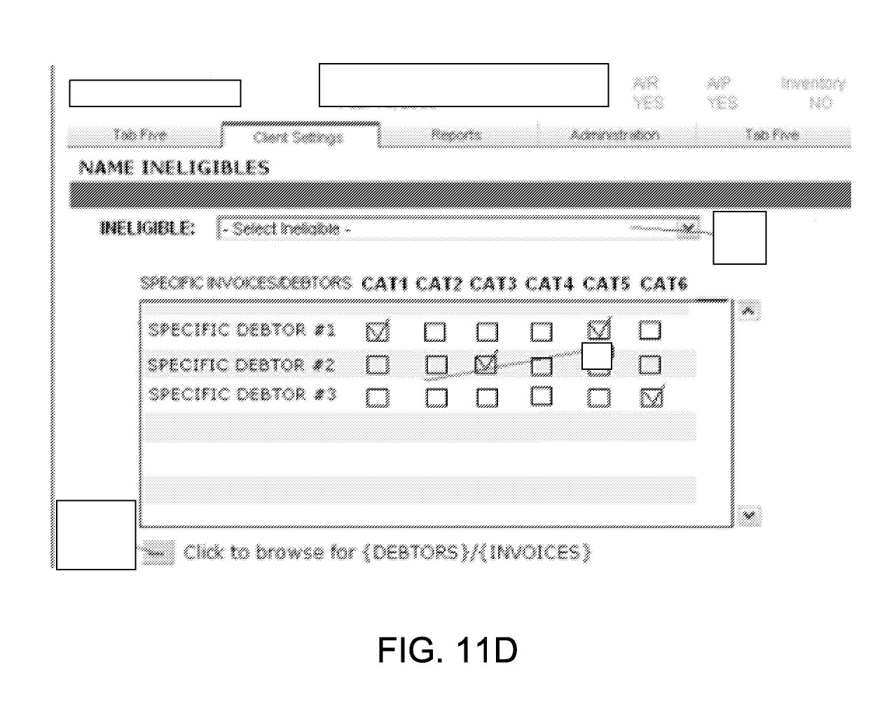

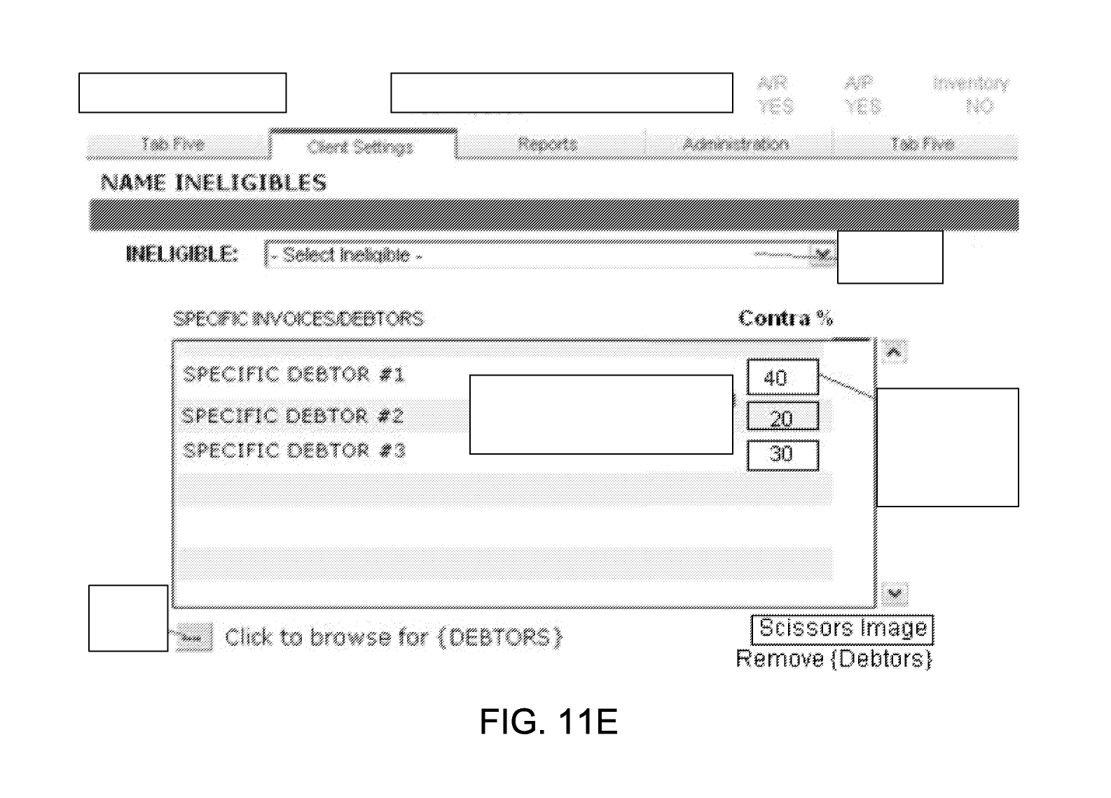

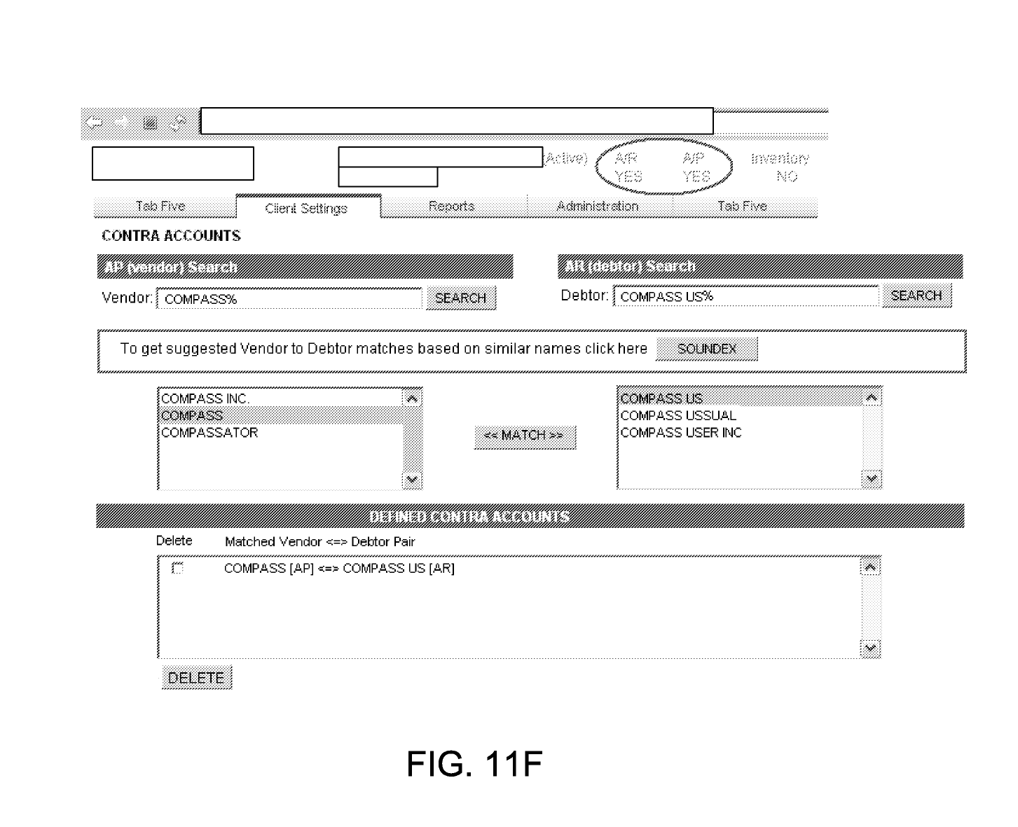

FIG. 11A shows a screen shot of an illustrative embodiment for naming or defining the ineligibles for a particular client according to such an aspect of this disclosure. As seen in FIG. 11A, if any individual debtors or invoices have already been named (i.e., already exist) they will be displayed when the user selects the particular ineligible (e.g., chooses an ineligible, from the drop down menu containing a list of ineligibles shown in FIG. 11A). In order to add a specific debtor or invoice to the ineligible, the user can browse for particular debtors and invoices using the browse feature shown in FIG. 11A. For example, FIG. 11B shows a screen shot of an illustrative embodiment for searching for a particular invoice according to such an aspect of this disclosure. Further, FIG. 11C shows a screen shot of an illustrative embodiment for searching for a particular debtor according to such an aspect of this disclosure.

As seen in FIG. 11A, the user will have the opportunity to define particular rules or definitions for a particular invoice by using the drop down menus for the invoice type field and its respective value fields shown in the lower half of the screen shot. Similarly, the user will have the opportunity to define particular rules or definitions for a particular debtor by using the drop down menus for each of MISC #1 or MISC #2 fields and their respective values fields shown in the lower half of the screen shot.

Additionally, the system may include a module that configures the system to provide the user with the opportunity to create rules or definitions which classify inventories into particular ineligible categories.

Additionally, the user can also define (and store) exceptions for the client specific rules described above. For example, the user may have set up a client specific rule that defines any debt between 90-120 days from the invoice date as ineligible. However, in step 219, the user may create an exception to this client rule for a particular debtor. For example, if a particular debtor is known as extremely reliable, then the user may provide an exception for that debtor wherein any debts by that debtor are considered eligible collateral regardless of the age of the debt. Therefore, the system will interpret any debts in the client's A/R from that particular debtor that are between 90-120 days from invoice as eligible collateral instead of ineligible collateral. Further, the user can also define exceptions for particular invoices/debts or for particular inventories.

For example, FIG. 11D shows a screen shot of an illustrative embodiment for defining debtor specific rules for aging categories of debtors of a particular client according to such an aspect of this disclosure. A similar process could be used for defining invoice specific rules. Similarly, FIG. 11E shows a screen shot of an illustrative embodiment for defining debtor specific rules for a concentration percentage of a debtor of a particular client according to such an aspect of this disclosure. A similar process could be used for defining invoice specific rules.

Step 221 includes defining contra accounts. For example, the system may include a module that configures the system to provide the user with the opportunity to define and store contra accounts. Contra accounts arise when a client both sells to and borrows from a customer (i.e., debtor/vendor) on credit, so the customer appears on both the accounts receivable aging and the accounts payable aging. If the client fails to pay the liability, it may be offset against the accounts receivable. In such a situation the lower of the A/R or A/P balance will be considered ineligible collateral.

The following calculation sequence can be used to determine contra accounts:
Is the debtor's remaining eligible A/R balance>0?
Is the vendor's total A/P balance>0?
If so, the lower of the debtor's remaining eligible A/R balance and vendor's total A/P balance is ineligible.

The system may allow the user to match the debtors and vendors who appear on both the accounts receivable and the accounts payable aging. Therefore, the user may be able to match receivable and payable accounts where they are the same entity and the possibility of offset (rather than payment of the accounts receivable accounts) exists. Hence, the amount designated as offset will be included in the contra designation of ineligible, if it is not already considered ineligible for other reasons.

FIG. 11F is a screen shot of an illustrative embodiment for matching receivable and payable accounts where they are the same entity and the possibility of offset exists according to such an aspect of this disclosure. As seen in FIG. 11F, the user can enter a client (e.g., in this case Compass) in both the Accounts Payable/Vendor and Accounts Receivable/Debtor search boxes. Using the search system described above, the system will then pull “like” Vendors and Debtors. The user can then match a displayed vendor with a displayed debtor and can define the pair as a contra account. As seen in FIG. 11F, vendor “Compass” has been matched with debtor “Compass US” and defined as a contra account. Therefore, the system may use this definition in its ineligible collateral determination and calculations.

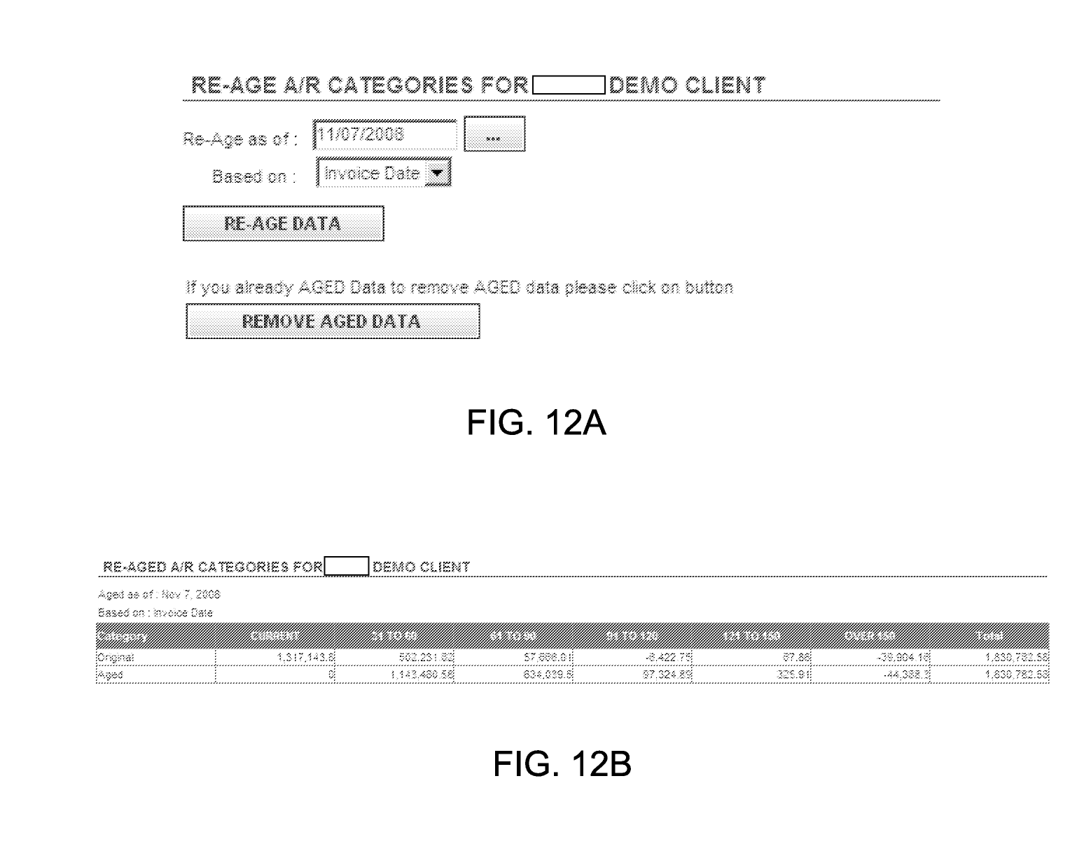

Step 223 includes re-aging client data based on the “re-aging start date” and “re-aging end date” that have been defined earlier in the process. For example, the system may include a module that configures the system to provide the user with the opportunity to re-age the client data (e.g., the A/R, A/P, etc.) based on the “re-aging start date” and “re-aging end date” that have been defined earlier in the process (see step 209). FIG. 12A is a screen shot of an illustrative embodiment for performing the re-aging according to such an aspect of this disclosure. The client can choose dates, such as the invoice date or the due date from which to base the re-aging calculations. It is noted that an Invoice Date aging spreads the accounts receivable based upon the date the invoices was issued. The report date minus the invoice date provides the total number of days from issuance for categorization. Similarly, a Due Date aging spreads the accounts receivable based upon the date an invoice was due for payment. The due date is the invoice date plus the terms of payment. The report date minus the due date provides the total number of days the invoice is past due for categorization. When the user has selected a date (e.g., an invoice date or a due date), the system may re-age the information according to the following formula:

(AGE_AS_OF_{—}DT)−INVOICE_{—}DT or DUE DT=NUMBER_OF_DAYS.

The system may then utilize settings that the user has provided for the particular client to place/allocate the amount in certain aging categories (Aging category 1 through 6). FIG. 12B is a screen shot of an illustrative embodiment for wherein the information has been re-aged according to above process.

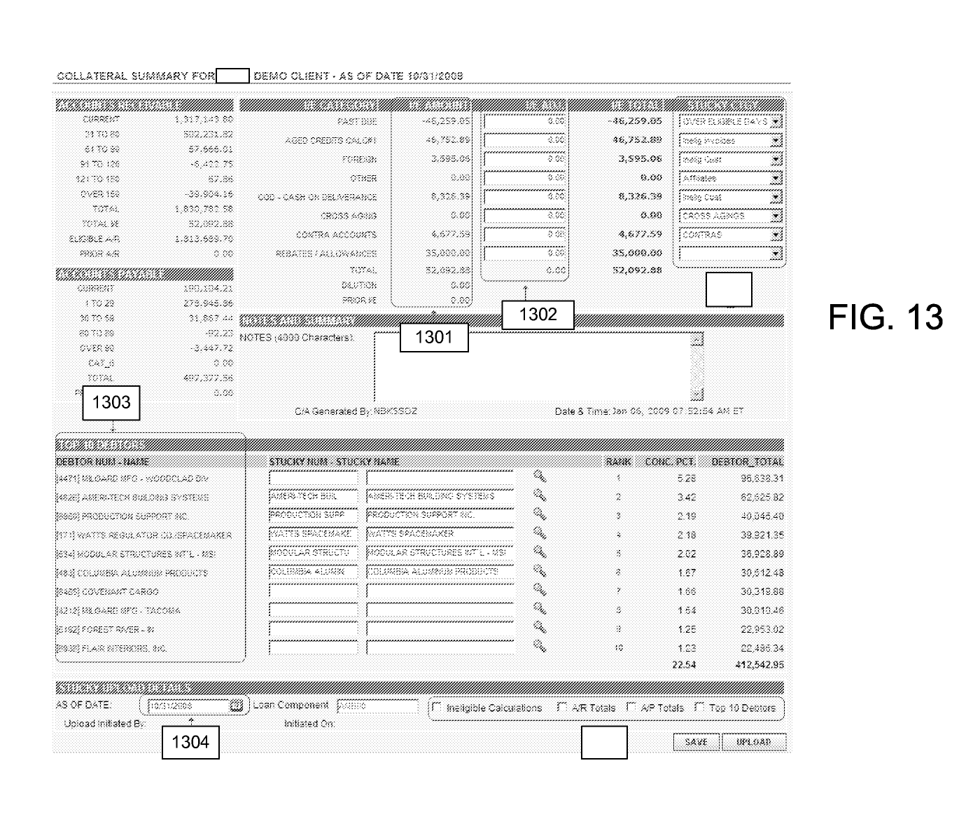

Once the above described client information as been entered, and the definitions, rules, exceptions created, Step 225 includes determining and calculating the ineligible collateral for the client based on the definitions, rules, exceptions, etc. provided by the user and producing a collateral summary. For example, the system may include a module that configures the system to determine and calculate the ineligible collateral for the client based on the definitions, rules, exceptions, etc. provided by the user and produce a collateral summary. A collateral summary is a summary that can include many different pieces of information about the client data and particularly the ineligible collateral. For example, FIG. 13 is a screen shot of an illustrative embodiment showing the collateral summary according to such an aspect of this disclosure. As seen in FIG. 13, the collateral summary includes information about the A/R. A/P, ineligible collateral, etc. In particular, reference numeral 1301 denotes the ineligible hierarchy for client as defined in step 217 and values for each ineligible category. Reference numeral 1302 denotes any adjustments to the calculated ineligible collateral that have entered by the user. Reference numeral 1303 denotes the top ten debtors sorted with full detail. Reference numeral 1304 indicates the date of the ineligible calculation.

Once the ineligible collateral has been calculated, Step 227 includes sending some or all of the ineligible collateral calculation data to another database or system within the lender. For example, the system may include a module that configures the system to provide the user with the opportunity to send some or all of the ineligible collateral calculation data to another database or system within the lender (e.g., another loan system within the lender) that may use the ineligible collateral calculations as data in further calculations (e.g., in order to ultimately determine a borrowing base for the client, etc.). For example, the collateral summary (or some of the information within the collateral summary) can be electronically transmitted to another system of record within the lender wherein it may be saved in the system of record and available to be incorporated into further calculations.

It is noted that the above described system is merely an illustrative example and many variations may be implemented without departing from the spirit of the disclosure. For example, some features or steps in the process may be removed. Also, some of the steps in the process may be performed in a different order.

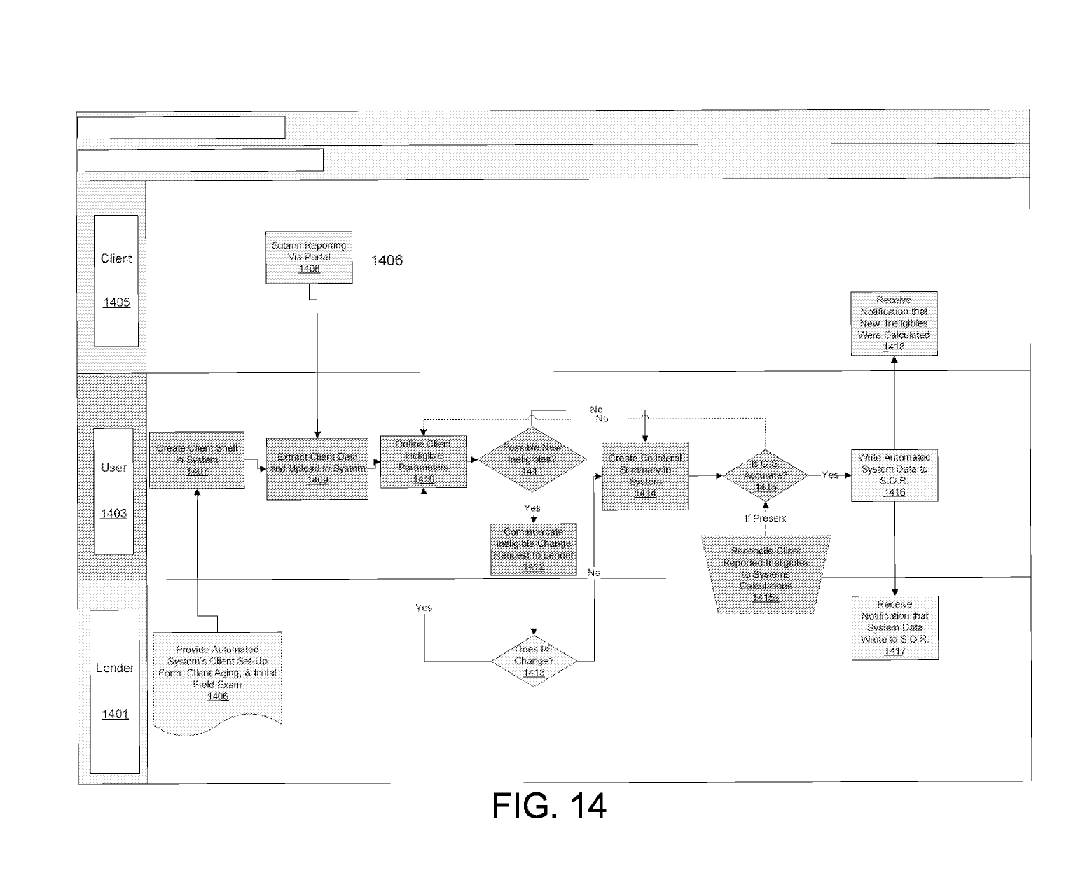

FIG. 14 is a diagram which illustrates aspects of the present system and the interactions between the lender 1401, the user of the system (which is some cases may be an associate within the lender) 1403, the client 1405. As seen in FIG. 14, in step 1406 the lender 1401 provides the user 1403 with information to create the client shell (e.g., a client record) and, in turn, the user 1403 creates the client shell in step 1407. In step 1408, the client 1405 submits the Client Source Report via a portal (e.g., a web portal) and, in turn, the user 1403 extracts the data from the Client Source Report using the Detailed Extraction Template and uploads it to the system. In step 1410, the user defines ineligible parameters (as described in detail above). In step 1411, the user has the opportunity to update possible new ineligibles. If there are new ineligibles, then in step 1412, the user requests approval from the lender for the change. If the change is approved in step 1413, the process returns to step 1410. If the change is not approved (or if there were no new ineligibles), then the process continues on to step 1414 wherein the system calculates the client data and creates the collateral summary (as described in detail above). In step 1415, the collateral summary is reviewed of accuracy. This may include the client reported ineligibles being reconciled with the systems calculations as seen in step 1415a. If the collateral summary is not accurate, then the process returns to step 1410. If the collateral summary is accurate, then in step 1416 the collateral summary (or some of the information in it) is forwarded to system of record (i.e., a database of the system or a related data base or system). In step 1417, the lender receives notification that the information has been forwarded to and saved in a system of record. In step 1418, the client receives notification of any new ineligibles that were calculated. Of course, the above example is merely illustrative and many variations may be implemented without departing from the spirit of the disclosure.

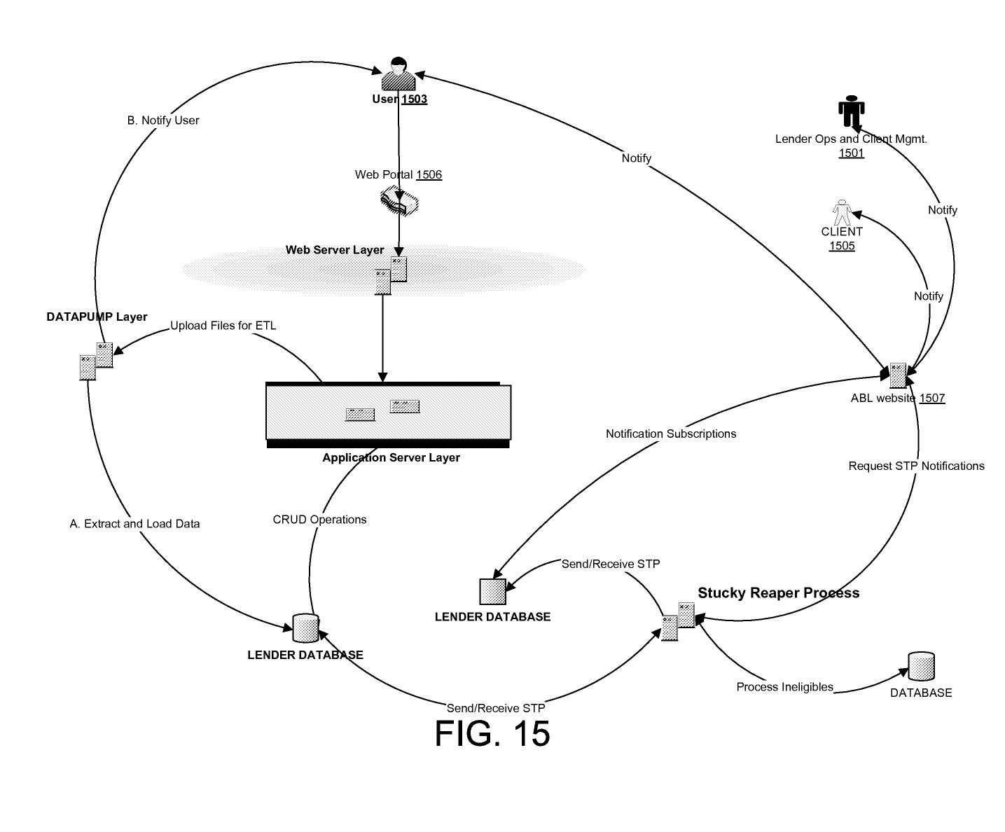

FIG. 15 is a diagram which illustrates aspects of the present system and the interactions between the system and related systems and databases of the lender. As seen in FIG. 15, the system involves a lender 1501, the user of the system (which in some cases may be an associate within the lender) 1503, the client 1505. As seen in FIG. 15, the user 1503 provides information via a web portal 1506. Further, as seen the information provided by the user 1503, is uploaded for ETL and the extracted data is forwarded to a database. Upon the data being extracted, transformed and loaded to the database, the user is notified (e.g., by an email created by the system). Additionally, as seen in FIG. 15, the data is used to process the ineligibles (through the processes described above in detail) and the ineligibles are forwarded to a database (e.g., a system of record). Also, such ineligibles or other data may be forwarded on to the lender 1501, user 1503 or the client 1505. Also, as seen the ineligibles or other data may be available for the any of those parties to view via ABL website 1507. Of course, the above example is merely illustrative and many variations may be implemented without departing from the spirit of the disclosure.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A computer comprising:
a processor; and
memory storing computer executable instructions that, when executed, cause the computer to perform a method for determining and calculating ineligible collateral, by:
receiving data relating to assets or collateral of a client,
determining and calculating ineligible collateral based on the data by applying one or more rules or definitions regarding ineligible collateral to the data,
wherein the rules and definitions applied to the collateral are variable based on a particular client to which the data relates.

2. The computer according to claim 1, wherein the computer is configured to allow a user of the system to create and store rules and definitions that are specific to a particular client.

3. The computer according to claim 2, wherein the computer is configured to allow the user to create and store rules and definitions that are specific to individual debtors of a client's account's receivable, wherein the computer applies the rules and definitions for individual debtors in determining and calculating ineligible collateral.

4. The computer according to claim 3, wherein the computer is configured to allow the user to create and store rules and definitions that are specific to individual invoices of a client's accounts receivable, wherein the computer applies the rules and definitions for individual invoices in determining and calculating ineligible collateral.

5. The computer according to claim 2, wherein the computer is configured to allow the user to create and store rules and definitions for individual aging categories for data relating to either a client's accounts receivable or a client's account payable, wherein the computer applies the rules and definitions for the individual aging categories in determining and calculating ineligible collateral.

6. The computer according to claim 5, wherein the computer is configured to allow the user to designate as past due, individual aging categories for client data relating to either accounts receivable or account payable, wherein the computer interprets any amount in an aging category designated as past due as ineligible collateral when the computer determines and calculates ineligible collateral.

7. The computer according to claim 5, wherein the computer is configured to allow the user to define a time period for re-aging individual aging categories for client data relating to either accounts receivable or account payable, wherein the computer re-ages the client data based on the user defined time periods in determining and calculating ineligible collateral.

8. The computer according to claim 2, wherein the computer is configured to allow the user to create and store rules and definitions for a concentration of a client's accounts receivable, wherein the computer applies the rules and definitions for the concentration of the client's accounts receivable in determining and calculating ineligible collateral.

9. The computer according to claim 2, wherein the computer is configured to allow the user to create and store rules and definitions for a cross-aging of a client's accounts receivable, wherein the computer applies the rules and definitions for the cross-aging of the client's accounts receivable in determining and calculating ineligible collateral.

10. The computer according to claim 2, wherein the computer is configured to allow the user to create and store rules and definitions for a contra-account of a client's accounts receivable and a client's accounts payable, wherein the computer applies the rules and definitions for the contra-account in determining and calculating ineligible collateral.

11. The computer according to claim 2, wherein the computer is configured to allow the user to combine different debtors from a client's accounts receivable into a single debtor, wherein the computer is configured to allow the user to search for different debtors from the client's accounts receivable by searching for one or more characters of a debtor's name and the computer is configured to display a list of debtors from the client's accounts receivable that match the one or more characters.

12. The computer according to claim 2, wherein the computer is configured to allow the user to combine different vendors from a client's accounts payable into a single vendor, wherein the computer is configured to allow the user to search for different vendors from the client's accounts payable by searching for one or more characters of a vendor's name and the computer is configured to display a list of vendors from the client's accounts payable that match that the one or more characters.

13. The computer according to claim 4, wherein the computer is configured to allow the user create and store a hierarchy that defines the order in which the computer will apply the rules and definitions that are specific to individual debtors of the client's accounts receivable and the rules and definitions that are specific to individual invoices of the client's accounts receivable.

14. The computer according to claim 2, wherein once the computer has determined and calculated the ineligible collateral for the client based on the rules definitions, the computer is configured to produce and store a collateral summary which includes at least one piece of information about the client data and the ineligible collateral.

15. The computer according to claim 14, wherein once the computer determined and calculated the ineligible collateral for the client based on the rules and definitions, the computer is configured to provide the user the ability to electronically transmit some or all of the information about the ineligible collateral.

16. A computer comprising:
a processor; and;
memory storing computer executable instructions that, when executed, cause the computer to perform a method for determining and calculating ineligible collateral, by:
receiving client data relating to assets or collateral of a client;
receiving a detailed extraction template including a list of different fields;
searching the client data for relevant data that corresponds to the different fields of the detailed extraction template;
extracting the relevant data that corresponds to the different fields of the detailed extraction template;
creating a summary of the relevant data;
determining and calculating ineligible collateral based on the client data,
wherein the step of determining and calculating ineligible collateral includes applying one or more rules or definitions regarding ineligible collateral to the relevant data in the summary,
wherein the rules and definitions applied to the collateral are variable based on a particular client to which the data relates.

17. The computer according to claim 16, wherein once the summary has been created, the computer is configured to create and send an email indicating that the process is complete.

18. A computer assisted method for determining and calculating ineligible collateral comprising:
electronically receiving data relating to assets or collateral of a client,
using a computer to determine and calculate ineligible collateral based on the data by applying one or more rules or definitions regarding ineligible collateral to the data,
wherein the rules and definitions applied to the collateral are variable based on a particular client to which the data relates,
wherein the rules and definitions are stored in the computer.

19. The computer assisted method according to claim 18, wherein the computer is configured to allow a user of the system to create and store rules and definitions that are specific to a particular client.

20. The computer assisted method according to claim 19, wherein the computer is configured to allow the user to create and store rules and definitions that are specific to individual debtors of a client's account's receivable, wherein computer is configured to allow the user to create rules and definitions that are specific to individual invoices of the client's accounts receivable, wherein the computer applies the rules and definitions for individual debtors and individual invoices in determining and calculating ineligible collateral.
